(19) United States
(12) Patent Application Publication
(10) Pub. No.: US 2022/0181619 A1
(43) Pub. Date: Jun. 9, 2022

(54) METHOD FOR MANUFACTURING POSITIVE ELECTRODE ACTIVE MATERIAL

(71) Applicant: SEMICONDUCTOR ENERGY LABORATORY CO., LTD., ATSUGI-SHI, KANAGAWA-KEN (JP)

(72) Inventors: Yohei MOMMA, Isehara, Kanagawa (JP); Teruaki OCHIAI, Atsugi, Kanagawa (JP); Mayumi MIKAMI, Atsugi, Kanagawa (JP); Kazuhito MACHIKAWA, Hiratsuka, Kanagawa (JP); Jo SAITO, Atsugi, Kanagawa (JP)

(21) Appl. No.: 17/601,250

(22) PCT Filed: Mar. 30, 2020
(86) PCT No.: PCT/IB2020/052989

§ 371 Date: Oct. 4, 2021

(30) Foreign Application Priority Data
Apr. 12, 2019 (JP) 2019-076181

(51) Int. Cl. H01M 4/525; H01M 4/36; H01M 4/04; H01M 4/505; H01M 4/58

(52) U.S. Cl. CPC H01M 4/525; H01M 4/364; H01M 4/0471; H01M 2004/028; H01M 4/582; H01M 4/043; H01M 4/505

(57) ABSTRACT

Provided is a positive electrode active material that achieves improvement in load resistance such as rate performance and output resistance when used as a positive electrode active material in a lithium-ion secondary battery, achieves improvement in powder properties, has a short manufacturing cycle time, and is low in cost. The positive electrode active material is manufactured by a first step of forming a first mixture by separately pulverizing a compound containing one or more elements selected from magnesium, calcium, zirconium, lanthanum, and barium; a compound containing halogen and an alkali metal; and a fluoride containing one or more metals selected from nickel, aluminum, manganese, titanium, vanadium, iron, and chromium, and then mixing them with metal oxide powder; and a second step of performing heating at a temperature higher than or equal to 700° C. and lower than or equal to 950° C.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, and an electronic device including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, tablets, and laptop computers, portable music players, digital cameras, medical equipment, and next-generation clean energy vehicles (e.g., hybrid vehicles (HVs), electric vehicles (EVs), and plug-in hybrid vehicles (PHVs)); for example. The lithium-ion secondary batteries are essential as rechargeable energy supply sources for today's information society.

The performance required for lithium-ion secondary batteries includes much higher energy density, improved cycle performance, safety under a variety of operation environments, and improved long-term reliability.

In view of the above, improvement of positive electrode active materials has been studied to improve the cycle performance and increase the capacity of lithium-ion secondary batteries (Patent Document 1 and Patent Document 2). In addition, crystal structures of positive electrode active materials have been studied (Non-Patent Document 1 to Non-Patent Document 3).

Non-Patent Document 4 discloses the physical properties of metal fluorides.

X-ray diffraction (XRD) is one of methods used for analysis of a crystal structure of a positive electrode active material. With the use of the Inorganic Crystal Structure Database (ICSD) described in Non-Patent Document 5, XRD data can be analyzed.

### REFERENCE

### Patent Document

[Patent Document 1] Japanese Published Patent Application No. 2002-216760
[Patent Document 2] Japanese Published Patent Application No. 2006-261132

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12) A1604-A1609.
[Non-Patent Document 4] W. E. Counts et al., “Fluoride Model Systems: II, The Binary Systems CaF₂—BeF₂2, MgF₂—BeF₂, and LiF—MgF₂”, Journal of the American Ceramic Society (1953), 36 [1], 12-17. FIG. 01471.
[Non-Patent Document 5] Belsky, A. et al., “New developments in the Inorganic Crystal Structure Database (ICSD): accessibility in support of materials research and design”, Acta Cryst. (2002), B58, 364-369.

### SUMMARY OF THE INVENTION

### Problems to be Solved by the Invention

An object of one embodiment of the present invention is to provide a positive electrode active material that has high capacity and excellent charge-and-discharge cycle performance for a lithium-ion secondary battery, and a manufacturing method thereof. Another object of one embodiment of the present invention is to provide a method for manufacturing a positive electrode active material with high productivity. Another object of one embodiment of the present invention is to provide a positive electrode active material that suppresses a decrease in capacity in charge and discharge cycles when used for a lithium-ion secondary battery. Another object of one embodiment of the present invention is to provide a high-capacity secondary battery. Another object of one embodiment of the present invention is to provide a secondary battery with excellent charge and discharge performance. Another object of one embodiment of the present invention is to provide a positive electrode active material in which elution of a transition metal such as cobalt is inhibited even when a state being charged with high voltage is held for a long time. Another object of one embodiment of the present invention is to provide a highly safe or reliable secondary battery.

Another object of one embodiment of the present invention is to provide a novel material, novel active material particles, a novel power storage device, or a manufacturing method thereof.

Note that the description of these objects does not preclude the existence of other objects. One embodiment of the present invention does not have to achieve all these objects. Note that other objects can be taken from the description of the specification, the drawings, and the claims.

### Means for Solving the Problems

One embodiment of the present invention is a method for manufacturing a positive electrode active material, including a first step of forming a first mixture by separately pulverizing a compound containing an element X, a compound containing halogen and an alkali metal, and a metal fluoride and then mixing them with powder of a metal oxide; and a second step of performing heating at a temperature higher than or equal to 700° C. and lower than or equal to 950° C. The element X is one or more selected from magnesium, calcium, zirconium, lanthanum, and barium. The metal fluoride contains one or more selected from nickel, aluminum, manganese, titanium, vanadium, iron, and chromium. The metal oxide contains one or more selected from cobalt, manganese, nickel, and iron.

In the above embodiment, the average particle diameter of the obtained positive electrode active material is preferably greater than or equal to 1 μm and less than or equal to 100 μm. In the above embodiment, the metal oxide preferably has a structure represented by a space group R-3m. In the above embodiment, the metal oxide is preferably lithium cobalt oxide.

Another embodiment of the present invention is a method for manufacturing a positive electrode active material, including a first step of forming a first mixture by separately pulverizing magnesium fluoride, lithium fluoride, and aluminum fluoride and then mixing them with powder of a metal oxide; and a second step of performing heating at a temperature higher than or equal to 700° C. and lower than or equal to 950° C. The metal oxide contains a metal M. The metal M is selected from cobalt, manganese, nickel, and iron.

In the above embodiment, in the first mixture, the number of atoms of magnesium contained in the magnesium fluoride is preferably greater than or equal to 0.005 times and less than or equal to 0.05 times the number of atoms of the metal M contained in the metal oxide. In the above embodiment, in the first mixture, the number of atoms of aluminum contained in the aluminum fluoride is preferably greater than or equal to 0.0005 times and less than or equal to 0.02 times the sum of the number of atoms of the metal M contained in the metal oxide and the number of atoms of aluminum contained in the aluminum fluoride. In the above embodiment, the average particle diameter of the obtained positive electrode active material is preferably greater than or equal to 1 μm and less than or equal to 100 μm. In the above embodiment, the metal oxide preferably has a structure represented by a space group R-3m. In the above embodiment, the metal oxide is preferably lithium cobalt oxide.

Another embodiment of the present invention is a method for manufacturing a positive electrode active material, including a first step of forming a first mixture by separately pulverizing magnesium fluoride, lithium fluoride, a nickel compound, and aluminum fluoride and then mixing them with powder of a metal oxide; and a second step of performing heating at a temperature higher than or equal to 700° C. and lower than or equal to 950° C. The metal oxide contains a metal M. The metal M is one or more selected from cobalt, manganese, nickel, and iron.

In the above embodiment, the nickel compound is preferably nickel hydroxide. In the above embodiment, in the first mixture, the number of atoms of magnesium contained in the magnesium fluoride is preferably greater than or equal to 0.005 times and less than or equal to 0.05 times the number of atoms of the metal M contained in the metal oxide. In the above embodiment, in the first mixture, the number of atoms of aluminum contained in the aluminum fluoride is preferably greater than or equal to 0.0005 times and less than or equal to 0.02 times the sum of the number of atoms of the metal M contained in the metal oxide and the number of atoms of aluminum contained in the aluminum fluoride. In the above embodiment, the average particle diameter of the obtained positive electrode active material is preferably greater than or equal to 1 μm and less than or equal to 100 μm. In the above embodiment, the metal oxide preferably has a structure represented by a space group R-3m. In the above embodiment, the metal oxide is preferably lithium cobalt oxide.

### Effect of the Invention

According to one embodiment of the present invention, a positive electrode active material that has high capacity and excellent charge-and-discharge cycle performance for a lithium-ion secondary battery, and a manufacturing method thereof can be provided. A method for manufacturing a positive electrode active material with high productivity can be provided. A positive electrode active material that suppresses a decrease in capacity in charge and discharge cycles when used for a lithium-ion secondary battery can be provided. A high-capacity secondary battery can be provided. A secondary battery with excellent charge and discharge performance can be provided. A positive electrode active material in which elution of a transition metal such as cobalt is inhibited even when a state being charged with high voltage is held for a long time can be provided. A highly safe or reliable secondary battery can be provided. A novel material, novel active material particles, a novel power storage device, or a manufacturing method thereof can be provided.

### BRIEF DESCRIPTION OF THE DRAWINGS

FIG. 1A is a diagram illustrating a method for manufacturing a material. FIG. 1B is a diagram illustrating a method for manufacturing a material.

FIG. 2A is a diagram illustrating a method for manufacturing a positive electrode active material.

FIG. 2B is a diagram illustrating a method for manufacturing a positive electrode active material.

FIG. 3 is a diagram illustrating a method for manufacturing a positive electrode active material.

FIG. 4 is a diagram illustrating a method for manufacturing a positive electrode active material.

FIG. 5A is a diagram illustrating a coin-type secondary battery. FIG. 5B is a diagram illustrating a coin-type secondary battery. FIG. 5C is a diagram illustrating charging of a secondary battery.

FIG. 6A is a diagram illustrating a cylindrical secondary battery. FIG. 6B is a diagram illustrating a cylindrical secondary battery. FIG. 6C is a diagram illustrating cylindrical secondary batteries.

FIG. 6D is a diagram illustrating cylindrical secondary batteries.

FIG. 7A is a diagram illustrating an example of a secondary battery. FIG. 7B is a diagram illustrating an example of a secondary battery.

FIG. 8A is a diagram illustrating an example of a secondary battery. FIG. 8B is a diagram illustrating an example of a secondary battery. FIG. 8C is a diagram illustrating an example of a secondary battery. FIG. 8D is a diagram illustrating an example of a secondary battery.

FIG. 9A is a diagram illustrating an example of a secondary battery. FIG. 9B is a diagram illustrating an example of a secondary battery.

FIG. 10 is a diagram illustrating an example of a secondary battery.

FIG. 11A is a diagram illustrating a laminated secondary battery. FIG. 11B is a diagram illustrating a laminated secondary battery. FIG. 11C is a diagram illustrating a laminated secondary battery.

FIG. 12A is a diagram illustrating a laminated secondary battery. FIG. 12B is a diagram illustrating a laminated secondary battery.

FIG. 13 is an external view of a secondary battery.

FIG. 14 is an external view of a secondary battery.

FIG. 15A is a diagram for illustrating a method for manufacturing a secondary battery. FIG. 15B is a diagram for illustrating a method for manufacturing a secondary battery. FIG. 15C is a diagram for illustrating a method for manufacturing a secondary battery.

FIG. 16A is a diagram illustrating a bendable secondary battery. FIG. 16B is a diagram illustrating a bendable secondary battery. FIG. 16C is a diagram illustrating a bendable secondary battery. FIG. 16D is a diagram illustrating a bendable secondary battery. FIG. 16E is a diagram illustrating a bendable secondary battery.

FIG. 17A is a diagram illustrating a bendable secondary battery. FIG. 17B is a diagram illustrating a bendable secondary battery.

FIG. 18A is a diagram illustrating an example of an electronic device. FIG. 18B is a diagram illustrating an example of an electronic device. FIG. 18C is a diagram illustrating an example of a secondary battery. FIG. 18D is a diagram illustrating an example of an electronic device. FIG. 18E is a diagram illustrating an example of a secondary battery. FIG. 18F is a diagram illustrating an example of an electronic device. FIG. 18G is a diagram illustrating an example of an electronic device. FIG. 18H is a diagram illustrating an example of an electronic device.

FIG. 19A is a diagram illustrating an example of an electronic device. FIG. 19B is a diagram illustrating an example of an electronic device. FIG. 19C is a diagram illustrating an example of an electronic device.

FIG. 20 is a diagram illustrating examples of electronic devices.

FIG. 21A is a diagram illustrating an example of a vehicle. FIG. 21B is a diagram illustrating an example of a vehicle. FIG. 21C is a diagram illustrating an example of a vehicle.

FIG. 22A is a diagram illustrating examples of electronic devices. FIG. 22B is a diagram illustrating an example of an electronic device. FIG. 22C is a diagram illustrating an example of an electronic device.

FIG. 23 is a diagram showing DSC.

FIG. 24 is a diagram showing DSC.

FIG. 25 is a diagram showing DSC.

FIG. 26A is a diagram showing cycle performance of secondary batteries. FIG. 26B is a diagram showing cycle performance of secondary batteries.

FIG. 27A is a diagram showing cycle performance of secondary batteries. FIG. 27B is a diagram showing cycle performance of secondary batteries.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (−) at the front of a number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region from a surface to a depth of approximately 10 nm. A plane generated by a crack may also be referred to as a surface. In addition, a region whose position is deeper than that of the surface portion is referred to as an inner portion.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, a pseudo-spinel crystal structure of a composite oxide containing lithium and a transition metal refers to a crystal structure with a space group R-3m, which is not a spinel crystal structure but a crystal structure where oxygen is hexacoordinated to ions of cobalt, magnesium, or the like and the cation arrangement has symmetry similar to that of the spinel crystal structure. Note that in the pseudo-spinel crystal structure, oxygen is tetracoordinated to a light element such as lithium in some cases. Also in that case, the ion arrangement has symmetry similar to that of the spinel crystal structure.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of a pseudo-spinel crystal are also presumed to have a cubic close-packed structure. When the pseudo-spinel crystal is in contact with the layered rock-salt crystal and the rock-salt crystal, there is a crystal plane at which orientations of cubic close-packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

Whether the crystal orientations in two regions are substantially aligned can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, theoretical capacity of a positive electrode active material refers to the amount of electricity at the time when lithium that can be inserted and extracted and is contained in the positive electrode active material is all extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, charge depth at the time when lithium that can be inserted and extracted is all inserted is 0, and charge depth at the time when lithium that can be inserted and extracted and is contained in a positive electrode active material is all extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a charge depth of greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. A positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The discharging rate refers to the relative ratio of current at the time of discharging to battery capacity and is expressed in a unit C. A current corresponding to 1 C in a battery with a rated capacity X (Ah) is X (A). The case where discharging is performed at a current of 2X (A) is rephrased as to perform discharging at 2 C, and the case where discharging is performed at a current of X/5 (A) is rephrased as to perform discharging at 0.2 C. The same applies to the charging rate; the case where charging is performed at a current of 2X (A) is rephrased as to perform charging at 2 C, and the case where charging is performed at a current of X/5 (A) is rephrased as to perform charging at 0.2 C.

Constant-current charging refers to, for example, a method of performing charging at a constant charging rate. Constant-voltage charging refers to, for example, a method of performing charging with a voltage that is set constant when reaching the upper limit voltage during charging. Constant-current discharging refers to, for example, a method of performing discharging at a constant discharging rate.

### Embodiment 1

In this embodiment, a positive electrode active material of one embodiment of the present invention and a manufacturing method thereof will be described.

The positive electrode active material of one embodiment of the present invention contains a metal A, a transition metal Mt, an element X, a metal M(2), and oxygen. Moreover, the positive electrode active material of one embodiment of the present invention may contain a metal M(1).

The metal A is an alkali metal. Alternatively, an alkaline earth metal may be used as the metal A.

The transition metal Mt is preferably one or more of cobalt, manganese, nickel, and iron, for example.

The element X is one or more selected from magnesium, calcium, zirconium, lanthanum, and barium, for example.

The positive electrode active material of one embodiment of the present invention contains the element X, whereby in a secondary battery using the positive electrode active material of one embodiment of the present invention, the stability of the structure of the positive electrode active material can be increased even with high charge voltage, for example. The increase in charge voltage can increase the discharge capacity and energy density. Moreover, the increase in stability of the structure results in an improvement in cycle performance and the like.

The metal M(2) is one or more selected from nickel, aluminum, manganese, titanium, vanadium, iron, and chromium, for example, particularly preferably one or more of nickel and aluminum, further preferably aluminum. The metal M(1) is one or more selected from nickel, aluminum, manganese, titanium, vanadium, iron, and chromium, for example, and is preferably a metal different from the metal M(2).

Preferably, the transition metal Mt is a metal different from the metal M(2). Further preferably, the transition metal Mt is a metal different from the metal M(1) and the metal M(2).

The positive electrode active material of one embodiment of the present invention contains the metal M(2) in addition to the element X, whereby in the secondary battery using the positive electrode active material of one embodiment of the present invention, the safety may be increased, for example. In addition, the stability of the structure of the positive electrode active material at high charge voltage can be further increased in some cases. Furthermore, the charge voltage can be further increased in some cases.

When the positive electrode active material of one embodiment of the present invention contains the metal M(1) in addition to the element X and the metal M(2), in the secondary battery using the positive electrode active material of one embodiment of the present invention, the stability of the structure of the positive electrode active material at high charge voltage can be further increased in some cases, for example. In addition, the discharge capacity increases further in some cases.

### <Manufacturing Method 1 of Positive Electrode Active Material>

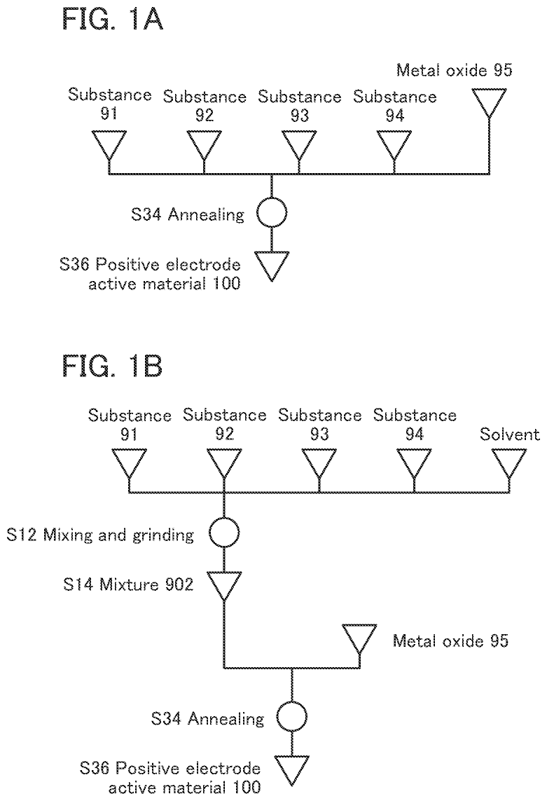

A method for manufacturing a positive electrode active material of one embodiment of the present invention will be described below with reference to FIG. 1A and FIG. 1B.

In the manufacturing procedure illustrated in FIG. 1A, a metal oxide containing the metal A and the transition metal Mt (hereinafter a metal oxide 95) and a plurality of substances (hereinafter a substance 91, a substance 92, a substance 93, and a substance 94) are mixed, and annealing is performed (Step S34), whereby a positive electrode active material 100 is obtained (Step S36). Although four substances are shown here as an example of the plurality of substances, the number of the plurality of substances may be three or less or may be five or more. For example, the plurality of substances may be three substances of the substance 91, the substance 92, and the substance 94.

In the manufacturing procedure illustrated in FIG. 1B, the substance 91 to the substance 94 are prepared, mixing and grinding are performed in Step S12 to fabricate a mixture 902 (Step S14), the mixture 902 and the metal oxide 95 are mixed, and annealing is performed (Step 34), whereby the positive electrode active material 100 is obtained (Step S36).

By grinding the substance 91 to the substance 94 in advance, the substance 91 to the substance 94 may be easily attached to the surface of the metal oxide 95 in the annealing process in Step S34. In addition, the area where the metal oxide 95 is in contact with the substance 91 to the substance 94 may increase. Thus, one or more of the elements contained in the substance 91 to the substance 94 may be easily added to the metal oxide 95.

Although FIG. 1B shows an example in which a solvent as well as the substance 91 to the substance 94 is prepared and mixing is performed by a wet method, the solvent is not necessarily prepared in the case where mixing is performed by a dry method.

The metal oxide 95 is preferably a particle.

Alternatively, the metal oxide 95 may be a thin film formed by a CVD (Chemical vapor deposition) method, a sputtering method, an evaporation method, or the like. The thin film is formed over a substrate, for example. As the substrate, a variety of modes such as foil of an after-mentioned material that can be used for a current collector, a glass substrate, and a resin substrate can be used, for example.

As the metal oxide 95, an oxide having a layered rock-salt crystal structure can be used, for example. As another example, an oxide having a spinel crystal structure can be used. As another example, a phosphate compound, a silicate compound, or the like may be used as the metal oxide 95.

In the case where the metal oxide 95 is an oxide having a layered rock-salt crystal structure, cobalt, manganese, nickel, or aluminum, for example, is used as the transition metal Mt. Examples of materials containing such a transition metal Mt include lithium cobalt oxide, lithium manganese oxide, lithium nickel oxide, lithium cobalt oxide in which cobalt is partly replaced with manganese, lithium cobalt oxide in which cobalt is partly replaced with nickel, and lithium nickel-manganese-cobalt oxide.

As the metal oxide 95, an oxide having a structure represented by a space group R-3m is used, for example.

In the case where the metal oxide 95 is an oxide having a spinel crystal structure, manganese or nickel, for example, is used as the transition metal Mt.

Some of the elements contained in the substance 91 to the substance 94 are preferably added to the surface and a region in the vicinity of the surface of the metal oxide 95 or an inner portion of the metal oxide 95 by the above mixing and annealing. Furthermore, some of the elements contained in the metal oxide 95 may be replaced with some of the elements contained in the substance 91 to the substance 94 by the above mixing and annealing.

When some of the elements contained in the substance 91 to the substance 94 are added to the metal oxide 95, increase in capacity, increase in energy density, improvement in cycle performance, improvement in reliability, or improvement in safety, for example, can be achieved in a secondary battery using the positive electrode active material of one embodiment of the present invention.

As the substance 91, a halogen compound containing the metal A can be used.

When lithium is used as the metal A, lithium fluoride or lithium chloride can be used as the substance 91, for example. In particular, lithium fluoride is preferable because it is easily melted in the annealing process described later. When sodium is used as the metal A, sodium fluoride or sodium chloride can be used as the substance 91, for example. When potassium is used as the metal A, potassium fluoride can be used as the substance 91, for example. When calcium is used as the metal A, calcium chloride can be used as the substance 91, for example.

The substance 92 is a compound containing the element X.

When magnesium is used as the element X, magnesium fluoride, magnesium oxide, magnesium hydroxide, magnesium carbonate, or magnesium chloride can be used as the substance 92, for example.

When a mixture of the above-described compound containing the element X and the halogen compound containing the metal A is annealed, a eutectic reaction occurs, and melting can be caused in at least part of a region of the mixture at a temperature lower than the melting point of the compound containing the element X.

In the case where the element X is an element that does not contribute to charge and discharge reactions of the positive electrode active material, an excessive addition amount of the element might significantly decrease the obtained discharge capacity. With the use of the method for manufacturing the positive electrode active material of one embodiment of the present invention, the concentration of the element X can be made higher on the surface and in the vicinity of the surface of the metal oxide 95 than in the inner portion of the metal oxide 95. When the concentration gradient of the element X is caused in the metal oxide 95 so that the concentration of the element X is higher on the surface and in the vicinity of the surface, the effect can be efficiency obtained in some cases even with a small amount of the element X added to the whole positive electrode active material.

For example, the ratio {(Ax1)/(Am1)} of the number of atoms of the element X (Ax1) to the number of atoms of the transition metal Mt (Am1) in a first region whose distance from the surface is greater than or equal to 20 nm and less than or equal to 200 nm is higher than the ratio {(Ax2)/(Am2)} of the number of atoms of the element X (Ax2) to the number of atoms of the transition metal Mt (Am2) in a second region whose distance from the surface is greater than or equal to 1 μm and less than or equal to 3 μm.

When the substance 91 and the substance 92 are mixed and annealed, a eutectic reaction preferably occurs. Alternatively, the eutectic point is preferably lowered. Alternatively, a eutectic crystallization reaction preferably occurs. Alternatively, the eutectic crystallization point is preferably lowered. The following description of a eutectic reaction between the substance 91 and the substance 92 may apply to a decrease in eutectic point, a eutectic crystallization reaction, and a decrease in eutectic crystallization point.

When a eutectic reaction occurs between the substance 91 and the substance 92 in the case where the substance 91 and the substance 92 are mixed and annealed, the mixture of the substance 91 and the substance 92 is melted at a temperature lower than the melting points of the substance 91 and the substance 92, and at least one of the elements contained in the substance 91 and the substance 92 is easily added to the metal oxide 95.

The substance 93 is a compound containing the metal M(1). The substance 94 is a compound containing the metal M(2). The substance 93 and the substance 94 preferably function as metal sources in the manufacture of the positive electrode active material of one embodiment of the present invention.

When the concentration gradient of the metal M(2) is caused in the metal oxide 95 so that the concentration of the metal M(2) is higher on the surface and in the vicinity of the surface, the effect can be efficiency obtained in some cases even with a small amount of the metal M(2) added to the whole positive electrode active material.

For example, the ratio {(Amb1)/(Am1)} of the number of atoms of the metal M(2) (Amb1) to the number of atoms of the transition metal Mt (Am1) in a first region whose distance from the surface is greater than or equal to 20 nm and less than or equal to 200 nm is higher than the ratio {(Amb2)/(Am2)} of the number of atoms of the element X (Amb2) to the number of atoms of the transition metal Mt (Am2) in a second region whose distance from the surface is greater than or equal to 1 μm and less than or equal to 3 μm.

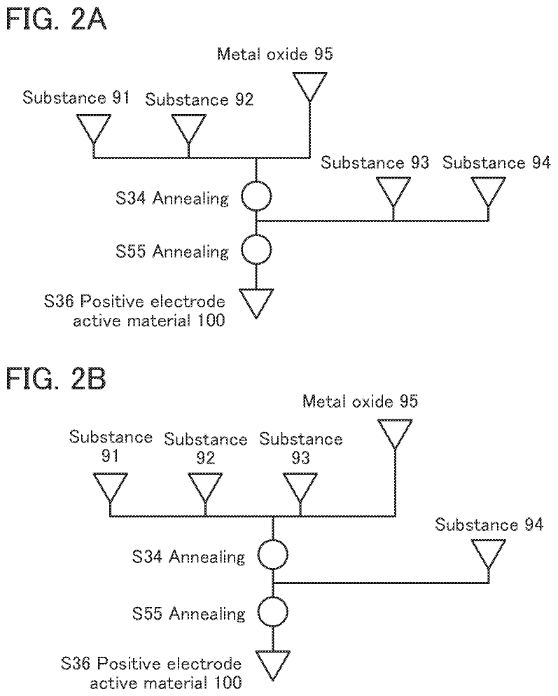

When one or both of the substance 93 and the substance 94 significantly inhibit the eutectic reaction between the substance 91 and the substance 92, annealing may be divided into two steps as shown in FIG. 2A and FIG. 2B. Specifically, substances other than the substance that inhibits the eutectic reaction are mixed, annealing is performed (Step S34), one or more elements contained in at least one of the substance 91 and the substance 92 are added to the metal oxide 95, and then the substance that inhibits the eutectic reaction is added and mixed, and annealing is performed (Step S55); thus, the positive electrode active material 100 is obtained (Step S36).

In FIG. 2A, the substance 91, the substance 92, and the metal oxide 95 are mixed, annealing is performed (Step S34), the substance 93, the substance 94, and the annealed mixture are mixed, and annealing is performed (Step S55); hence, the positive electrode active material 100 is obtained (Step S36). In FIG. 2B, the substance 91, the substance 92, the substance 93, and the metal oxide 95 are mixed, annealing is performed (Step S34), the substance 94 and the annealed mixture are mixed, and annealing is performed (Step S55); thus, the positive electrode active material 100 is obtained (Step S36).

For example, in the case where the substance 94 significantly inhibits the eutectic reaction, the process in FIG. 2A or FIG. 2B is employed. As another example, in the case where both the substance 93 and the substance 94 significantly inhibit the eutectic reaction, the process in FIG. 2A is employed.

Performing annealing twice reduces the productivity and leads to a cost increase; thus, the annealing process is preferably performed once as shown in FIG. 1A. Therefore, it is preferred that the substance 93 and the substance 94 not inhibit the eutectic reaction between the substance 91 and the substance 92 as much as possible. Specifically, for example, the substance 93 and the substance 94 are preferably highly stable at a temperature lower than the temperature at which the eutectic reaction between the substance 91 and the substance 92 occurs. For example, the substance 93 and the substance 94 preferably have low reactivity with the element X at a temperature lower than the temperature at which the eutectic reaction occurs.

Meanwhile, if the stability of the substance 93 and the substance 94 is too high, the substance 93 and the substance 94 are not easily added to the metal oxide 95 in the annealing process in some cases. Thus, it is preferable that the melting points of the substance 93 and the substance 94 not be much higher than the temperature of the annealing process. For example, in the case where the melting points of the substance 93 and the substance 94 are higher than the temperature of the annealing process, the difference between the temperature of the annealing process and the melting points is preferably lower than or equal to 500° C., further preferably lower than or equal to 400° C., still further preferably lower than or equal to 300° C. Furthermore, in addition to the substance 91 and the substance 92, one or both of the substance 93 and the substance 94 may cause a eutectic reaction.

A eutectic reaction can be evaluated using DSC (differential scanning calorimetry), for example.

### <DSC>

In DSC, the measurement temperature is scanned, and a change in the amount of heat is observed. The change in the amount of heat is caused, for example, by an endothermic reaction such as melting and an exothermic reaction such as crystallization.

When a eutectic reaction occurs between the substance 91 and the substance 92, a change in the amount of heat that indicates an endothermic reaction, for example, is observed at and around the reaction temperature.

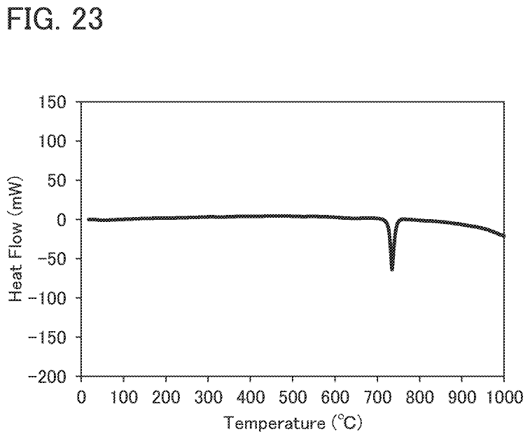

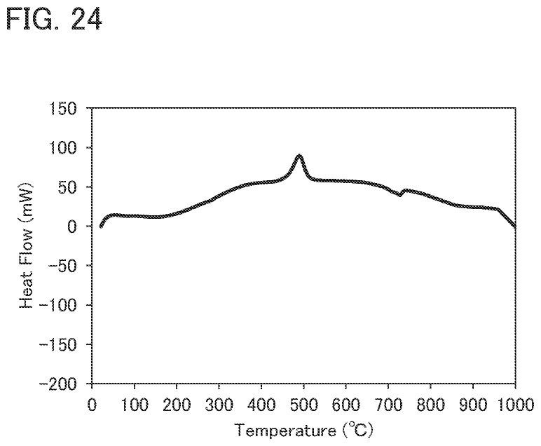

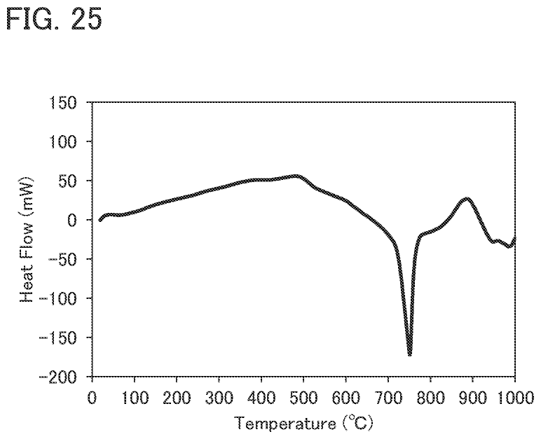

Examples of the substance 91, the substance 92, and the substance 94 in the case where magnesium and aluminum are respectively used as the element X and the metal M(2) are shown below, and evaluation results with DSC are shown in FIG. 23, FIG. 24, and FIG. 25. In FIG. 23, FIG. 24, and FIG. 25, the horizontal axis represents temperature and the vertical axis represents heat flow.

FIG. 23 shows an example of DSC of a mixture of the substance 91 and the substance 92. Here, lithium fluoride is used as the substance 91, and magnesium fluoride is used as the substance 92.

FIG. 24 shows an example of DSC of a mixture of the substance 91, the substance 92, and the substance 94. Here, lithium fluoride is used as the substance 91, magnesium fluoride is used as the substance 92, and aluminum hydroxide is used as the substance 94.

FIG. 25 shows an example of DSC of a mixture of the substance 91, the substance 92, and the substance 94. Here, lithium fluoride is used as the substance 91, magnesium fluoride is used as the substance 92, and aluminum fluoride is used as the substance 94.

Table 1 shows the substance 91, the substance 92, and the substance 94 that correspond to FIG. 23, FIG. 24, and FIG. 25.

TABLE 1

| | Substance 91 | Substance 92 | Substance 94 |
|---|---|---|---|
| FIG. 23 | Lithium fluoride | Magnesium fluoride | — |
| FIG. 24 | Lithium fluoride | Magnesium fluoride | Aluminum |
| | | | hydroxide |
| FIG. 25 | Lithium fluoride | Magnesium fluoride | Aluminum fluoride |

First, in FIG. 23, a peak indicating an endothermic reaction was observed at approximately 735° C. The melting point of lithium fluoride is 848° C., and the melting point of magnesium fluoride is 1263° C. The peak observed at approximately 735° C. probably indicates a reduction in the melting point of lithium fluoride due to a eutectic reaction, for example.

Next, in FIG. 24, a peak indicating an endothermic reaction was slightly observed at approximately 727° C.; however, the peak is significantly smaller than the peak observed at approximately 735° C. in FIG. 23. That is, a change in energy at the temperature is small. This indicates that addition of aluminum hydroxide inhibits a eutectic reaction between lithium fluoride and magnesium fluoride. Meanwhile, a peak indicating an exothermic reaction was observed at approximately 490° C., which indicates that magnesium contained in magnesium fluoride is bonded to aluminum contained in aluminum hydroxide. Thus, it is probable that the existence of aluminum hydroxide results in a shortage of magnesium fluoride which would cause a eutectic reaction with lithium fluoride, thereby inhibiting a eutectic reaction between lithium fluoride and magnesium fluoride.

Next, in FIG. 25, a peak indicating an endothermic reaction was observed at approximately 752° C., and a significant decrease in the peak intensity was not observed as compared to FIG. 23. This demonstrates that aluminum fluoride has a small effect on a eutectic reaction between lithium fluoride and magnesium fluoride and is preferable as the substance 94.

An example of a possible reason aluminum fluoride exhibits the characteristics shown in FIG. 25 is that aluminum fluoride has high stability at a temperature lower than the temperature at which a eutectic reaction between the substance 91 and the substance 92, here a eutectic reaction between lithium fluoride and magnesium fluoride, for example, occurs and is less likely to cause a reaction with magnesium contained in magnesium fluoride.

The scanning speed of the measurement temperature in the DSC shown in FIG. 23, FIG. 24, and FIG. 25 was 20° C./min.

From the DSC shown in FIG. 23, FIG. 24, and FIG. 25, aluminum fluoride, which has high stability at a temperature lower than the temperature at which a eutectic reaction between the halogen compound containing the metal A and the compound containing the element X occurs, is preferably used as the compound containing the metal M(2) in the method for manufacturing the positive electrode active material of one embodiment of the present invention.

<Manufacturing method 2 of positive electrode active material>

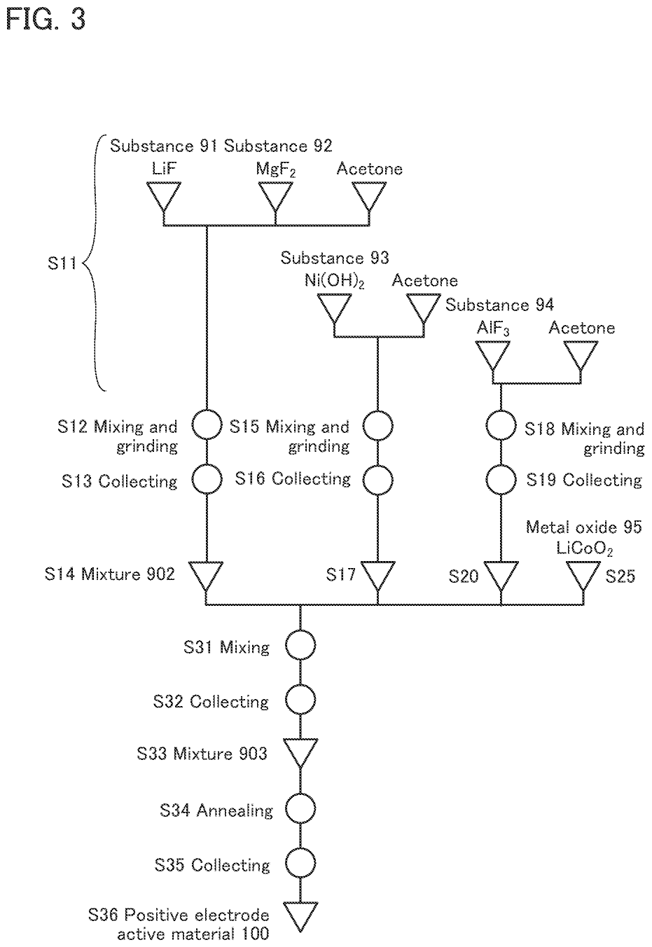

A method for manufacturing the positive electrode active material of one embodiment of the present invention will be described below with reference to FIG. 3.

### <Step S11>

First, materials of the mixture 902 are prepared.

When a compound containing fluorine is used as the substance 91, lithium fluoride or magnesium fluoride can be used, for example. In particular, lithium fluoride is preferably used.

When a compound containing magnesium is used as the substance 92, magnesium fluoride, magnesium oxide, magnesium hydroxide, or magnesium carbonate can be used, for example. As a lithium source, lithium fluoride or lithium carbonate can be used, for example.

In this embodiment, lithium fluoride LiF is prepared as the substance 91, and magnesium fluoride MgF₂ is prepared as the substance 92 (Step S11 in FIG. 3).

When lithium fluoride LiF and magnesium fluoride MgF₂ are mixed at approximately LiF:MgF₂=65:35 (molar ratio), the effect of reducing the melting point becomes the highest (Non-Patent Document 4). On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤×≤0.5), still further preferably LiF:MgF₂=x:1 (x=the vicinity of 0.33).

In addition, in the case where the following mixing and grinding step is performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used (see Step S11 in FIG. 3).

### <Step S12>

Next, the materials of the mixture 902 are mixed and ground (Step S12 in FIG. 3). Although the mixing can be performed by a dry process or a wet process, the wet process is preferable because the materials can be ground to a smaller size. For example, a ball mill, a bead mill, or the like can be used for the mixing. When the ball mill is used, a zirconia ball is preferably used as media, for example. By sufficiently performing this mixing and grinding step, the pulverized mixture 902 can be obtained in a later step.

The mixing is preferably performed with a blender, a mixer, or a ball mill.

### <Step S13 and Step S14>

The materials mixed and ground in the above manner are collected (Step S13 in FIG. 3), whereby the mixture 902 is obtained (Step S14 in FIG. 3).

For example, the mixture 902 preferably has an average particle diameter (D50) of greater than or equal to 600 nm and less than or equal to 20 μm, further preferably greater than or equal to 1 μm and less than or equal to 10 μm. When mixed with the metal oxide 95 in a later step, the mixture 902 pulverized to such a small size is easily attached to surfaces of particles of the metal oxide 95 uniformly. The mixture 902 is preferably attached to the surfaces of the particles of the metal oxide 95 uniformly, in which case halogen and magnesium are easily distributed to the entire surface portion of the particles of the metal oxide 95 after heating.

### <Step S15, Step S16, and Step S17>

Moreover, the substance 93 is prepared to be mixed in Step S31. Here, pulverized nickel hydroxide is prepared as the substance 93. Nickel hydroxide and acetone are mixed and ground (Step S15) and collected (Step S16), whereby pulverized nickel hydroxide is obtained (Step S17).

### <Step S18, Step S19, and Step S20>

Furthermore, the substance 94 is prepared to be mixed in Step S31. Pulverized aluminum fluoride is prepared as the substance 94. Aluminum fluoride and acetone are mixed and ground (Step S18) and collected (Step S19), whereby pulverized aluminum fluoride is obtained (Step S20).

Aluminum fluoride has a very small effect on a eutectic reaction between the substance 91 and the substance 92 when annealing is performed in subsequent Step S34, and thus is preferable as the substance 94.

### <Step S25>

Moreover, the metal oxide 95 is prepared in Step S25 to be mixed in Step S31.

As the metal oxide 95, a metal oxide containing few impurities is preferably used. In this specification and the like, in the metal oxide 95 containing the metal A and the transition metal Mt, the main components are the metal A, the transition metal Mt, and oxygen, and elements other than the main components are regarded as impurities. For example, when analyzed with a glow discharge mass spectroscopy method, the total impurity concentration is preferably less than or equal to 10000 ppm wt, further preferably less than or equal to 5000 ppm wt. In particular, the total impurity concentration of transition metals such as titanium and arsenic is preferably less than or equal to 3000 ppm wt, further preferably less than or equal to 1500 ppm wt.

For example, as the metal oxide 95, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

The metal oxide 95 in Step S25 preferably has a layered rock-salt crystal structure with few defects and distortions. Therefore, the metal oxide 95 is preferably a metal oxide with few impurities. If the metal oxide 95 includes a large amount of impurities, the crystal structure is highly likely to have a lot of defects or distortions.

### <Step S31>

Next, the mixture 902, the metal oxide 95, the pulverized aluminum fluoride, and the pulverized nickel hydroxide are mixed (Step S31 in FIG. 3).

The ratio of the number TM of atoms of the transition metal Mt in the metal oxide 95 to the number TX of atoms of the element X contained in the mixture 902 is preferably TM:TX=1:y (0.005≤y≤0.05), further preferably TM:TX=1:y (0.007≤y≤0.04), still further preferably TM:TX=approximately 1:0.02.

The number of atoms of the transition metal Mt in the metal oxide 95 is denoted by TM, and the number of atoms of the metal M(2) contained in the substance 94 is denoted by T2. In Step S31, (TM+T2):T2=1:z (0.0005≤z≤0.02) is preferable, (TM+T2):T2=1:z (0.001≤y≤0.015) is further preferable, and (TM+T2):T2=1:z (0.001≤y≤0.009) is still further preferable.

The number of atoms of the transition metal Mt in the metal oxide 95 is denoted by TM, and the number of atoms of the metal M(1) contained in the substance 94 is denoted by T1. In Step S31, (TM+T1):T1=1:z (0.0005≤z≤0.02) is preferable, (TM+T1):T1=1:z (0.001≤y≤0.015) is further preferable, and (TM+T1):T1=1:z (0.001≤y≤0.009) is still further preferable.

The condition of the mixing in Step S31 is preferably milder than that of the mixing in Step S12 in order not to damage the particles of the composite oxide. For example, a condition with a lower rotation frequency or shorter time than the mixing in Step S12 is preferable. In addition, it can be said that a dry process has a milder condition than a wet process. For example, a ball mill, a bead mill, or the like can be used for the mixing. When the ball mill is used, a zirconia ball is preferably used as media, for example.

### <Step S32 and Step S33>

The materials mixed in the above manner are collected (Step S32 in FIG. 3), whereby a mixture 903 is obtained (Step S33 in FIG. 3).

### <Step S34>

Next, the mixture 903 is heated (Step S34 in FIG. 3). This step is sometimes referred to as annealing or baking.

The annealing is preferably performed at an appropriate temperature for an appropriate time. The appropriate temperature and time depend on the conditions such as the particle size and the composition of the metal oxide 95 in Step S25. In the case where the particle size is small, annealing may be preferably performed at a lower temperature or for a shorter time than the case where the particle size is large.

The annealing temperature is preferably higher than or equal to the temperature at which the mixture 902 melts. When the mixture 903 is annealed, the mixture 902 is presumed to melt. For example, it is probable that a mixture of MgF₂ (melting point: 1263° C.) and LiF (melting point: 848° C.) melts and is distributed to a surface portion of composite oxide particles. Presumably, when MgF₂ melts, a reaction with LiCoO₂ is promoted and LiMO₂ is generated. For that reason, the fluoride and the magnesium source are preferably a combination that forms a eutectic mixture.

The annealing temperature is further preferably higher than or equal to the temperature at which the mixture 903 melts. Presumably, when the fluoride (e.g., LiF), the magnesium source (e.g., MgF₂), and lithium oxide (e.g., LiCoO₂) form a common mixture, generation of LiMO₂ is promoted.

The annealing temperature is preferably higher than or equal to the temperature at which the endothermic peak is observed by the DSC shown in FIG. 23, for example, preferably higher than or equal to 735° C., further preferably higher than or equal to 820° C. At temperatures around the decomposition temperature of LiCoO₂, which is approximately 1100° C., decomposition of a small amount of LiCoO₂ is concerned. For that reason, the annealing temperature is preferably lower than or equal to 1050° C., further preferably lower than or equal to 1000° C.

Consequently, the annealing temperature is preferably higher than or equal to 735° C. and lower than or equal to 1050° C., further preferably higher than or equal to 735° C. and lower than or equal to 1000° C. Moreover, the annealing temperature is preferably higher than or equal to 820° C. and lower than or equal to 1050° C., further preferably higher than or equal to 820° C. and lower than or equal to 1000° C.

The annealing time is preferably longer than or equal to 3 hours, further preferably longer than or equal to 10 hours, for example.

The temperature decreasing time after the annealing is, for example, preferably longer than or equal to 10 hours and shorter than or equal to 50 hours.

The elements contained in the mixture 903 are diffused faster in the surface portion and the vicinity of grain boundaries than in the inner portion of the particles of the metal oxide 95. Therefore, magnesium and halogen are higher in concentration in the surface portion and the vicinity of the grain boundaries than in the inner portion. As described later, the higher the magnesium concentration in the surface portion and the vicinity of the grain boundaries is, the more effectively the change in the crystal structure can be inhibited. Thus, it is possible to obtain a positive electrode active material that includes particles with a smooth surface and has a small surface roughness.

### <Step S35 and Step S36>

The material annealed in the above manner is collected (Step S35 in FIG. 3). Then, the particles are preferably made to pass through a sieve. Through the above steps, the positive electrode active material 100 of one embodiment of the present invention can be formed (Step S36 in FIG. 3).

### <Manufacturing Method 3 of Positive Electrode Active Material>

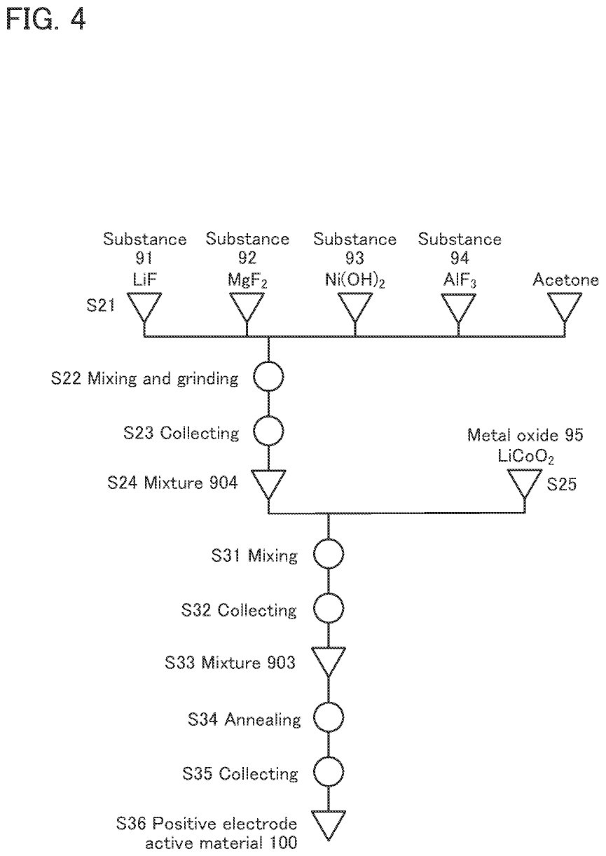

A method for manufacturing the positive electrode active material of one embodiment of the present invention will be described below with reference to FIG. 4.

The manufacturing method shown in FIG. 4 is the same as that in FIG. 3 except for some steps; hence, the description of identical steps is omitted for simplicity.

### <Step S21>

As shown in Step S21 in FIG. 4, first, the substance 91, the substance 92, the substance 93, and the substance 94 are prepared as materials for a mixture 904.

In this embodiment, lithium fluoride LiF is prepared as the substance 91, magnesium fluoride MgF₂ is prepared as the substance 92, nickel hydroxide is prepared as the substance 93, and aluminum fluoride is prepared as the substance 94 (Step S21).

Aluminum fluoride has a very small effect on a eutectic reaction between the substance 91 and the substance 92 when annealing is performed in subsequent Step S34, and thus is preferable as the substance 94.

How easily the eutectic reaction occurs may depend on the annealing atmosphere, pressure, and the total amount of materials to be annealed with respect to the volume of the treatment chamber of the annealing apparatus. Specifically, when the total amount of materials to be annealed is large, aluminum fluoride is preferably used as the substance 94 in order to process the materials more uniformly.

For example, when the total amount of powder is large, surfaces of the powder are less likely to be exposed to the annealing atmosphere in some cases. In order that each reaction in manufacturing the positive electrode active material is caused more stably even in such a case, aluminum fluoride is preferably used as the substance 94.

Moreover, a solvent used in the following mixing and grinding step performed by a wet method is prepared. As the solvent, acetone is used.

### <Step S22>

Next, the above materials are mixed and ground (S22 in FIG. 4). Although the mixing can be performed by a dry process or a wet process, the wet process is preferable because the materials can be ground to a smaller size. For example, a ball mill, a bead mill, or the like can be used for the mixing. When the ball mill is used, a zirconia ball is preferably used as media, for example. The mixing and grinding step is preferably performed sufficiently to pulverize the above materials.

### <Step S23 and Step S24>

The materials mixed and ground in the above manner are collected (Step S23), whereby the mixture 904 is obtained (Step S24).

### <Step S25>

In Step S25, the metal oxide 95 is used.

### <Step S31>

Next, the mixture 904 and the metal oxide 95 are mixed (Step S31).

The manufacturing steps subsequent to Step S31 are the same as those in FIG. 3, and thus the detailed description thereof is omitted. By following the manufacturing steps subsequent to Step S31, the positive electrode active material can be obtained in Step S36.

In this embodiment, Step S15 to Step S20 in FIG. 3 can be omitted.

### <Positive Electrode Active Material>

Next, examples of the structure of the positive electrode active material will be described.

### [Structure 1 of Positive Electrode Active Material]

The positive electrode active material preferably contains a metal serving as carrier ions (hereinafter an element A). As the element A, an alkali metal such as lithium, sodium, or potassium or a Group 2 element such as calcium, beryllium, or magnesium can be used, for example.

In the positive electrode active material, carrier ions are extracted from the positive electrode active material due to charging. A larger amount of the extracted element A means a larger amount of ions contributing to the capacity of a secondary battery, increasing the capacity. Meanwhile, a large amount of the extracted element A easily causes collapse of the crystal structure of a compound contained in the positive electrode active material. The collapse of the crystal structure of the positive electrode active material may lead to a decrease in the discharge capacity due to charge and discharge cycles. The positive electrode active material of one embodiment of the present invention contains the element X, whereby collapse of a crystal structure that would occur when carrier ions are extracted in charging of a secondary battery may be inhibited. Part of the element X substitutes for the element A, for example. An element such as magnesium, calcium, zirconium, lanthanum, or barium can be used as the element X As another example, an element such as copper, potassium, sodium, or zinc can be used as the element X Two or more of the elements described above as the element X may be used in combination.

Furthermore, the positive electrode active material of one embodiment of the present invention preferably contains halogen in addition to the element X. The positive electrode active material preferably contains halogen such as fluorine or chlorine. When the positive electrode active material of one embodiment of the present invention contains the halogen, substitution of the element X at the position of the element A is promoted in some cases.

The positive electrode active material of one embodiment of the present invention contains a metal whose valence number changes due to charge and discharge of a secondary battery (hereinafter an element Me). The element Me is a transition metal, for example. The positive electrode active material of one embodiment of the present invention contains one or more of cobalt, nickel, and manganese, particularly cobalt, as the element Me, for example. The positive electrode active material may contain, at the position of the element Me, an element with no valence change that can have the same valence as the element Me, specifically a trivalent representative element, such as aluminum, for example. The element X may substitute for the element Me, for example. In the case where the positive electrode active material of one embodiment of the present invention is an oxide, the element X may substitute for oxygen.

As the positive electrode active material of one embodiment of the present invention, a lithium composite oxide having a layered rock-salt crystal structure is preferably used, for example. Specifically, as the lithium composite oxide having a layered rock-salt crystal structure, lithium cobalt oxide, lithium nickel oxide, a lithium composite oxide containing nickel, manganese, and cobalt, or a lithium composite oxide containing nickel, cobalt, and aluminum can be used, for example. Moreover, such a positive electrode active material is preferably represented by a space group R-3m.

In the positive electrode active material having a layered rock-salt crystal structure, increasing the charge depth may cause collapse of a crystal structure. Here, collapse of a crystal structure refers to displacement of a layer, for example. In the case where collapse of a crystal structure is irreversible, the capacity of a secondary battery might be decreased by repeated charges and discharges.

The positive electrode active material of one embodiment of the present invention includes the element X, whereby the displacement of a layer can be suppressed even when the charge depth is increased, for example. By suppressing the displacement, a change in volume due to charge and discharge can be small. Accordingly, the positive electrode active material of one embodiment of the present invention can achieve excellent cycle performance. In addition, the positive electrode active material of one embodiment of the present invention can have a stable crystal structure in a high-voltage charged state. Thus, in the positive electrode active material of one embodiment of the present invention, a short circuit is less likely to occur while the high-voltage charged state is maintained. This is preferable because the safety is further improved.

The positive electrode active material of one embodiment of the present invention has a small change in the crystal structure and a small difference in volume per the same number of transition metal atoms between a sufficiently discharged state and a high-voltage charged state.

The positive electrode active material of one embodiment of the present invention may be represented by the chemical formula AM_{y}O_{z} (y>0, z>0). For example, lithium cobalt oxide may be represented by LiCoO₂. As another example, lithium nickel oxide may be represented by LiNiO₂.

When the charge depth is greater than or equal to 0.8, the positive electrode active material of one embodiment of the present invention, which contains the element X, may have a structure that is represented by the space group R-3m and is not a spinel crystal structure but is a structure where oxygen is hexacoordinated to ions of the element Me (e.g., cobalt), the element X (e.g., magnesium), and the like and the cation arrangement has symmetry similar to that of the spinel crystal structure. This structure is referred to as a pseudo-spinel crystal structure in this specification and the like. Note that in the pseudo-spinel crystal structure, oxygen is tetracoordinated to a light element such as lithium in some cases. Also in that case, the ion arrangement has symmetry similar to that of the spinel crystal structure.

Extraction of carrier ions due to charge makes the structure of a positive electrode active material unstable. The pseudo-spinel crystal structure is said to be a structure that can maintain high stability in spite of extraction of carrier ions.

In the case where the charge depth is high in the present invention, by using the positive electrode active material having the pseudo-spinel structure in a secondary battery, the structure of the positive electrode active material is stable at a voltage of approximately 4.6 V, preferably a voltage of approximately 4.65 V to 4.7 V with respect to the potential of a lithium metal, for example, and a decrease in capacity due to charge and discharge can be suppressed. Note that in the case where graphite is used as a negative electrode active material in a secondary battery, for example, the structure of the positive electrode active material is stable at a secondary battery voltage higher than or equal to 4.3 V and lower than or equal to 4.5 V, preferably higher than or equal to 4.35 V and lower than or equal to 4.55 V, for example, and a decrease in capacity due to charge and discharge can be suppressed.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have cubic close-packed structures (face-centered cubic lattice structures). Anions of the pseudo-spinel crystal are also presumed to have cubic close-packed structures. When the pseudo-spinel crystal is in contact with the layered rock-salt crystal and the rock-salt crystal, there is a crystal plane at which orientations of cubic close-packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

In the unit cell of the pseudo-spinel crystal structure, the coordinates of cobalt and oxygen can be represented by Co (0, 0, 0.5) and O (0, 0, x) within the range of 0.20≤×≤0.25.

In the positive electrode active material of one embodiment of the present invention, a difference between the volume of the unit cell with a charge depth of 0 and the volume per unit cell of the pseudo-spinel crystal structure with a charge depth of 0.82 is preferably less than or equal to 2.5%, further preferably less than or equal to 2.2%.

The pseudo-spinel crystal structure has diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60°).

Note that although the positive electrode active material of one embodiment of the present invention has the pseudo-spinel crystal structure when being charged with high voltage, not all the particles necessarily have the pseudo-spinel crystal structure. The particles may have another crystal structure, or some of the particles may be amorphous. Note that when the XRD patterns are analyzed by the Rietveld analysis, the pseudo-spinel crystal structure preferably accounts for more than or equal to 50 wt %, further preferably more than or equal to 60 wt %, still further preferably more than or equal to 66 wt % of the positive electrode active material. The positive electrode active material in which the pseudo-spinel crystal structure accounts for more than or equal to 50 wt %, further preferably more than or equal to 60 wt %, still further preferably more than or equal to 66 wt % can have sufficiently good cycle performance.

The number of atoms of the element X is preferably 0.001 to 0.1 times, further preferably larger than 0.01 times and less than 0.04 times, still further preferably approximately 0.02 times the number of atoms of the element Me. The concentration of the element X described here may be a value obtained by element analysis on the entire particle of the positive electrode active material using ICP-MS or the like, or may be a value based on the ratio of the raw materials mixed in the process of forming the positive electrode active material, for example.

In the case where cobalt and nickel are contained as the element Me, the proportion of nickel atoms (Ni) in the sum of cobalt atoms and nickel atoms (Co+Ni), that is, Ni/(Co+Ni) is preferably less than 0.1, further preferably less than or equal to 0.075.

<Metal oxide 95>

Next, examples of a material that can be used as the metal oxide 95 will be described.

As the metal oxide 95, various composite oxides can be used. For example, a compound such as LiFeO₂, LiCoO₂, LiNiO₂, LiMn₂O₄, Li₂MnO₃, V₂O₅, Cr₂O₅, or MnO₂ can be used.

As the material with a layered rock-salt crystal structure, for example, a composite oxide represented by LiMO₂ can be used. The element M is preferably one or more elements selected from Co and Ni. LiCoO₂ is preferable because it has high capacity, stability in the air, and thermal stability to a certain extent, for example. As the element M, one or more elements selected from Al and Mn may be included in addition to one or more elements selected from Co and Ni.

For example, it is possible to use LiNiₓMn_{y}Co₂O_{w} (e.g., x, y, and z are each ⅓ or a neighborhood thereof and w is 2 or a neighborhood thereof). As another example, it is possible to use LiNiₓMn_{y}Co₂O_{w} (e.g., x is 0.8 or a neighborhood thereof, y is 0.1 or a neighborhood thereof, z is 0.1 or a neighborhood thereof, and w is 2 or a neighborhood thereof). As another example, it is possible to use LiNiₓMn_{y}Co₂O_{w} (e.g., x is 0.5 or a neighborhood thereof, y is 0.3 or a neighborhood thereof, z is 0.2 or a neighborhood thereof, and w is 2 or a neighborhood thereof). As another example, it is possible to use LiNiₓMn_{y}Co₂O_{w} (e.g., x is 0.6 or a neighborhood thereof, y is 0.2 or a neighborhood thereof, z is 0.2 or a neighborhood thereof, and w is 2 or a neighborhood thereof). As another example, it is possible to use LiNiₓMn_{y}Co₂O_{w} (e.g., x is 0.4 or a neighborhood thereof, y is 0.4 or a neighborhood thereof, z is 0.2 or a neighborhood thereof, and w is 2 or a neighborhood thereof).

The neighborhood is, for example, a value greater than 0.9 times and smaller than 1.1 times the predetermined value.

As the metal oxide 95, for example, a solid solution obtained by combining two or more composite oxides can be used. For example, a solid solution of LiNiₓMn_{y}Co_{z}O₂ (x, y, z>0, x+y+z=1) and Li₂MnO₃ can be used.

As the material with a spinel crystal structure, for example, a composite oxide represented by LiM₂O₄ can be used. It is preferable to contain Mn as the element M For example, LiMn₂O₄ can be used. It is preferable to contain Ni in addition to Mn as the element M because the discharge voltage and the energy density of the secondary battery are increased in some cases. It is preferable to add a small amount of lithium nickel oxide (LiNiO₂ or LiNi₁₋ₓMₓO₂ (M=Co, Al, or the like)) to a lithium-containing material with a spinel crystal structure which contains manganese, such as LiMn₂O₄, because the characteristics of the secondary battery can be improved.

The average diameter of primary particles of the metal oxide 95 is preferably greater than or equal to 1 nm and less than or equal to 100 μm, further preferably greater than or equal to 50 nm and less than or equal to 50 μm, still further preferably greater than or equal to 1 μm and less than or equal to 30 μm, for example. The specific surface area is preferably greater than or equal to 1 m²/g and less than or equal to 20 m²/g. The average diameter of secondary particles is preferably greater than or equal to 5 μm and less than or equal to 50 μm. Note that the average particle diameters can be measured, for example, by observation using a SEM (scanning electron microscope) or a TEM or with a particle diameter distribution analyzer using a laser diffraction and scattering method. The specific surface area can be measured by a gas adsorption method.

A conductive material such as a carbon layer may be provided on the surface of the metal oxide 95. With the conductive material such as the carbon layer, the conductivity of the electrode can be increased. For example, the metal oxide 95 can be coated with a carbon layer by mixing a carbohydrate such as glucose at the time of baking the metal oxide 95. As the conductive material, graphene, multi-graphene, graphene oxide (GO), or RGO (Reduced Graphene Oxide) can be used. Note that RGO refers to a compound obtained by reducing graphene oxide (GO), for example.

A layer containing one or more of an oxide and a fluoride may be provided on the surface of the metal oxide 95. The oxide may have a composition different from that of the metal oxide 95. The oxide may have the same composition as the metal oxide 95.

As a polyanionic material, for example, a composite oxide containing oxygen, the element X, the metal A, and the metal M can be used. The metal M is one or more of Fe, Mn, Co, Ni, Ti, V, and Nb; the metal A is one or more of Li, Na, and Mg; and the element X is one or more of S, P, Mo, W, As, and Si.

As the material with an olivine crystal structure, for example, a composite material (general formula LiMPO₄ (M is one or more of Fe (II), Mn (II), Co (II), and Ni (II)) can be used. Typical examples of the general formula LiMPO₄ include lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}Co_{b}PO₄, LiFe_{c}Ni_{d}MnₑPO₄, LiNi_{c}Co_{d}MnₑPO₄ (c+d+≤e 1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

The average diameter of primary particles of the material with an olivine crystal structure is preferably greater than or equal to 1 nm and less than or equal to 20 μm, further preferably greater than or equal to 10 nm and less than or equal to 5 μm, still further preferably greater than or equal to 50 nm and less than or equal to 2 μm, for example. The specific surface area is preferably greater than or equal to 1 m²/g and less than or equal to 20 m²/g. The average diameter of secondary particles is preferably greater than or equal to 5 μm and less than or equal to 50 sm.

Alternatively, a composite material such as a general formula Li₍₂₋ⱼ₎MSiO₄ (M is one or more of Fe (II), Mn (II), Co (II), and Ni (II); 0≤j≤2) can be used. Typical examples of the general formula Li₍₂₋ⱼ₎MSiO₄ include lithium compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₖNiₗCo_{q}SiO₄, Li₍₂₋ⱼ₎FeₘNiₙMn_{q}SiO₄, Li₍₂₋ⱼ₎NiₘCoₙMn_{q}SiO₄ (m+n+q≤1, 0<m<1, 0<n<1, and 0<q<1), and Li₍₂₋ⱼ₎FeᵣNiₛCoₜMnᵤSiO₄ (r+s+t+u≤1,0<r<1,0<s<1,0<t<1, and 0<u<1).

Still alternatively, a NASICON compound represented by a general formula AₓM₂(XO₄)₃ (A=Li, Na, or Mg, M=Fe, Mn, Ti, V, or Nb, X=S, P, Mo, W, As, or Si) can be used. Examples of the NASICON compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn) can be used as the metal oxide 95.

Alternatively, a perovskite fluoride such as NaFeF₃ and FeF₃, a metal chalcogenide (a sulfide, a selenide, and a telluride) such as TiS₂ and MoS₂, an oxide with an inverse spinel crystal structure, such as LiMBO₄, a vanadium oxide (e.g., V₂O₅, V₆O₁₃, and LiV₃O₈), a manganese oxide, an organic sulfur compound, or the like can be used as the metal oxide 95.

Alternatively, a borate-based positive electrode material represented by a general formula LiMBO₃ (M is Fe (II), Mn (II), or Co (II)) can be used as the metal oxide 95.

Alternatively, a lithium-manganese composite oxide represented by a composition formula LiₐMn_{b}M_{c}O_{d} can be used as the metal oxide 95. Here, the element M is preferably a metal element other than lithium and manganese, or silicon or phosphorus, further preferably nickel. Furthermore, in the case where the whole particle of a lithium-manganese composite oxide is measured, it is preferable to satisfy the following at the time of discharging: 0<a/(b+c)<2; c>0; and 0.26 (b+c)/d<0.5. To achieve high capacity, the surface portion and the middle portion of the lithium-manganese composite oxide preferably include regions with different crystal structures, different crystal orientations, or different oxygen contents. In order to obtain such a lithium-manganese composite oxide, 1.6≤a≤1.848, 0.19≤c/b≤0.935, and 2.5≤d≤3 are preferably satisfied, for example.

As the metal oxide 95, for example, a material containing sodium, such as a sodium-containing oxide like NaFeO₂, Na_{2/3}[Fe_{1/2}Mn_{1/2}]O₂, Na_{2/3}[Ni_{1/3}Mn_{2/3}]O₂, Na₂Fe₂(SO₄)₃, Na₃V₂(PO₄)₃, Na₂FePO₄F, NaVPO₄F, NaMPO₄ (M is Fe (II), Mn (II), Co (II), or Ni (II)), Na₂FePO₄F, or Na₄Co₃(PO₄)₂P₂O₇ can be used.

As the metal oxide 95, a lithium-containing metal sulfide can be used. Examples of the lithium-containing metal sulfide are Li₂TiS₃ and Li₃NbS₄.

This embodiment can be implemented in appropriate combination with the other embodiments.

### Embodiment 2

In this embodiment, examples of materials that can be used in a secondary battery containing the positive electrode active material 100 described in the above embodiments will be described. In this embodiment, a secondary battery in which a positive electrode, a negative electrode, and an electrolyte solution are wrapped in an exterior body will be described as an example.

### [Positive Electrode]

The positive electrode includes a positive electrode active material layer and a positive electrode current collector.

### <Positive Electrode Active Material Layer>

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material 100 described in the above embodiment can be used. A secondary battery including the positive electrode active material 100 described in the above embodiment can have high capacity and excellent cycle performance.

Examples of the conductive additive include a carbon material, a metal material, and a conductive ceramic material. Alternatively, a fiber material may be used as the conductive additive. The content of the conductive additive in the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive additive. The conductive additive also allows the maintenance of a path for electric conduction between the positive electrode active materials. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Other examples of carbon fiber include carbon nanofiber and carbon nanotube. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as the conductive additive, in which case the area where the active material and the conductive additive are in contact with each other can be increased. A graphene compound that is the conductive additive is preferably formed using a spray dry apparatus as a coating film to cover the entire surface of the active material. In addition, a graphene compound is preferable because electrical resistance can be reduced in some cases. Here, it is particularly preferable to use, for example, graphene, multilayer graphene, or RGO as a graphene compound. Note that RGO refers to a compound obtained by reducing graphene oxide (GO), for example.

In the case where an active material with a small particle size (e.g., 1 μm or less) is used, the specific surface area of the active material is large and thus more conductive paths for the active materials are needed. Consequently, the amount of conductive additive tends to increase, and the carried amount of active material tends to decrease relatively. When the carried amount of active material decreases, the capacity of the secondary battery also decreases. In such a case, a graphene compound that can efficiently form a conductive path even with a small amount is particularly preferably used as the conductive additive because the carried amount of active material does not decrease.

As a graphene compound, graphene or multilayer graphene may be used, for example. Here, the graphene compound preferably has a sheet-like shape. The graphene compound may have a sheet-like shape formed of a plurality of sheets of multilayer graphene and/or a plurality of sheets of graphene that partly overlap each other.

In the longitudinal cross section of the active material layer, the sheet-like graphene compounds are preferably dispersed substantially uniformly in the active material layer. The plurality of graphene compounds are preferably formed to partly coat or adhere to the surfaces of a plurality of particles of the positive electrode active material so that the graphene compounds make surface contact with the particles of the positive electrode active material.

Here, the plurality of graphene compounds are bonded to each other, thereby forming a net-like graphene compound sheet (hereinafter referred to as a graphene compound net or a graphene net). The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

Here, it is preferable to perform reduction after a layer to be the active material layer is formed in such a manner that graphene oxide is used as the graphene compound and mixed with an active material. When graphene oxide with extremely high dispersibility in a polar solvent is used to form the graphene compounds, the graphene compounds can be substantially uniformly dispersed in the active material layer. The solvent is removed by volatilization from a dispersion medium containing the uniformly dispersed graphene oxide to reduce the graphene oxide; hence, the graphene compounds remaining in the active material layer partly overlap each other and are dispersed such that surface contact is made, thereby forming a three-dimensional conduction path. Note that graphene oxide can be reduced by heat treatment or with the use of a reducing agent, for example.

Unlike a particle of conductive additive such as acetylene black, which makes point contact with an active material, the graphene compound is capable of making low-resistance surface contact; accordingly, the electrical conduction between the particles of the positive electrode active material and the graphene compound can be improved with a smaller amount of the graphene compound than that of a normal conductive additive. This can increase the proportion of the positive electrode active material in the active material layer. Thus, the discharge capacity of the secondary battery can be increased.

With a spray dry apparatus, a graphene compound serving as a conductive additive can be formed in advance as a coating film to cover the entire surface of the active material, and a conductive path can be formed between the active materials using the graphene compound.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, and regenerated cellulose or starch can be used. It is further preferred that such water-soluble polymers be used in combination with any of the above rubber materials.

Alternatively, as the binder, a material such as polystyrene, poly(methyl acrylate), poly(methyl methacrylate) (polymethyl methacrylate, PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

The water-soluble polymers stabilize viscosity by being dissolved in water and allow stable dispersion of the active material and another material combined as a binder, such as styrene-butadiene rubber, in an aqueous solution. Furthermore, a water-soluble polymer is expected to be easily and stably adsorbed on the active material surface because it has a functional group. Many cellulose derivatives, such as carboxymethyl cellulose, have functional groups such as a hydroxyl group and a carboxyl group. Because of functional groups, polymers are expected to interact with each other and cover the active material surface in a large area.

In the case where the binder covering or being in contact with the active material surface forms a film, the film is expected to serve as a passivation film to suppress the decomposition of the electrolyte solution. Here, the passivation film refers to a film without electronic conductivity or a film with extremely low electric conductivity, and can suppress the decomposition of an electrolyte solution at a potential at which a battery reaction occurs in the case where the passivation film is formed on the active material surface, for example. It is preferred that the passivation film can conduct lithium ions while suppressing electric conduction.

### <Positive Electrode Current Collector>

The positive electrode current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. Still alternatively, the positive electrode current collector may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

### [Negative Electrode]

The negative electrode includes a negative electrode active material layer and a negative electrode current collector. The negative electrode active material layer may contain a conductive additive and a binder.

### <Negative Electrode Active Material>

As a negative electrode active material, for example, an alloy-based material or a carbon-based material can be used.

For the negative electrode active material, an element that enables charge-discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon, and silicon in particular has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by alloying and dealloying reactions with lithium and a compound containing the element, for example, may be referred to as an alloy-based material.

In this specification and the like, SiO refers, for example, to silicon monoxide. Note that SiO can alternatively be expressed as SiOₓ. Here, x preferably has an approximate value of 1. Alternatively, x is preferably more than or equal to 0.2 and less than or equal to 1.5, further preferably more than or equal to 0.3 and less than or equal to 1.2, for example.

As the carbon-based material, graphite, graphitizing carbon (soft carbon), non-graphitizing carbon (hard carbon), carbon nanotube, graphene, carbon black, and the like can be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector can be used. Note that a material that is not alloyed with carrier ions, such as lithium, is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₊ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) with a NASICON crystal structure (hereinafter LATP) is preferable because LATP contains aluminum and titanium, each of which is the element the positive electrode active material used for the secondary battery of one embodiment of the present invention is allowed to contain, and thus a synergistic effect of improving the cycle performance is expected. Moreover, higher productivity due to the reduction in the number of steps is expected. Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common comers are arranged three-dimensionally.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape and placed to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge and discharge at high voltage can be suppressed and thus the reliability of the secondary battery can be improved. In addition, when the separator is coated with the fluorine-based material, the separator is easily brought into close contact with an electrode, resulting in high output characteristics. When the separator is coated with the polyamide-based material, in particular, aramid, heat resistance is improved; thus, the safety of the secondary battery is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

### Embodiment 3

In this embodiment, examples of the shape of a secondary battery containing the positive electrode active material 100 described in the above embodiment will be described. The description of the above embodiment can be referred to for the materials used for the secondary battery described in this embodiment.

### [Coin-Type Secondary Battery]

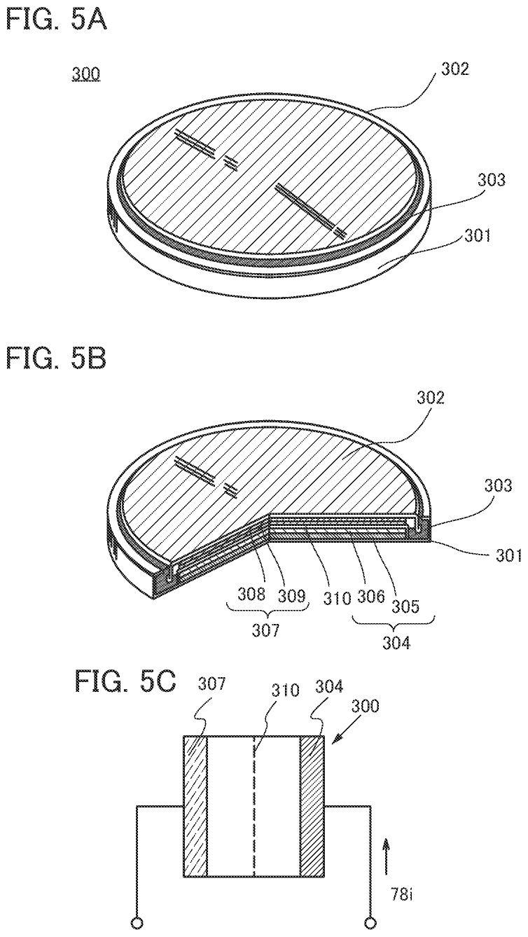

First, an example of a coin-type secondary battery is described. FIG. 5A is an external view of a coin-type (single-layer flat type) secondary battery, and FIG. 5B is a cross-sectional view thereof.

In a coin-type secondary battery 300, a positive electrode can 301 doubling as a positive electrode terminal and a negative electrode can 302 doubling as a negative electrode terminal are insulated and sealed by a gasket 303 formed of polypropylene or the like. A positive electrode 304 is formed of a positive electrode current collector 305 and a positive electrode active material layer 306 provided to be in contact with the positive electrode current collector 305. A negative electrode 307 is formed of a negative electrode current collector 308 and a negative electrode active material layer 309 provided to be in contact with the negative electrode current collector 308.

Note that an active material layer is formed on only one surface of each of the positive electrode 304 and the negative electrode 307 used in the coin-type secondary battery 300.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte; as illustrated in FIG. 5B, the positive electrode 304, the separator 310, the negative electrode 307, and the negative electrode can 302 are stacked in this order with the positive electrode can 301 positioned at the bottom; and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high capacity and excellent cycle performance can be obtained.

Here, a current flow in charging the secondary battery is described with reference to FIG. 5C. When the secondary battery using lithium is regarded as one closed circuit, the movement of lithium ions and the flow of current 78i are in the same direction. Note that in the secondary battery using lithium, an anode and a cathode interchange in charge and in discharge, and an oxidation reaction and a reduction reaction interchange; thus, an electrode with a high reaction potential is called a positive electrode and an electrode with a low reaction potential is called a negative electrode. For this reason, in this specification, the positive electrode is referred to as a “positive electrode” or a “+ electrode (plus electrode)” and the negative electrode is referred to as a “negative electrode” or a “− electrode (minus electrode)” in any of the case where charge is performed, the case where discharge is performed, the case where a reverse pulse current is made to flow, and the case where a charge current is made to flow. The use of the terms “anode” and “cathode” related to an oxidation reaction and a reduction reaction might cause confusion because the anode and the cathode interchange in charge and in discharge. Thus, the terms “anode” and “cathode” are not used in this specification. If the term “anode” or “cathode” is used, whether it is at the time of charging or discharging is noted, and whether it corresponds to a positive electrode (plus electrode) or a negative electrode (minus electrode) is also noted.

Two terminals illustrated in FIG. 5C are connected to a charger, and the secondary battery 300 is charged. As the charging of the secondary battery 300 proceeds, a potential difference between the electrodes increases.

### [Cylindrical Secondary Battery]

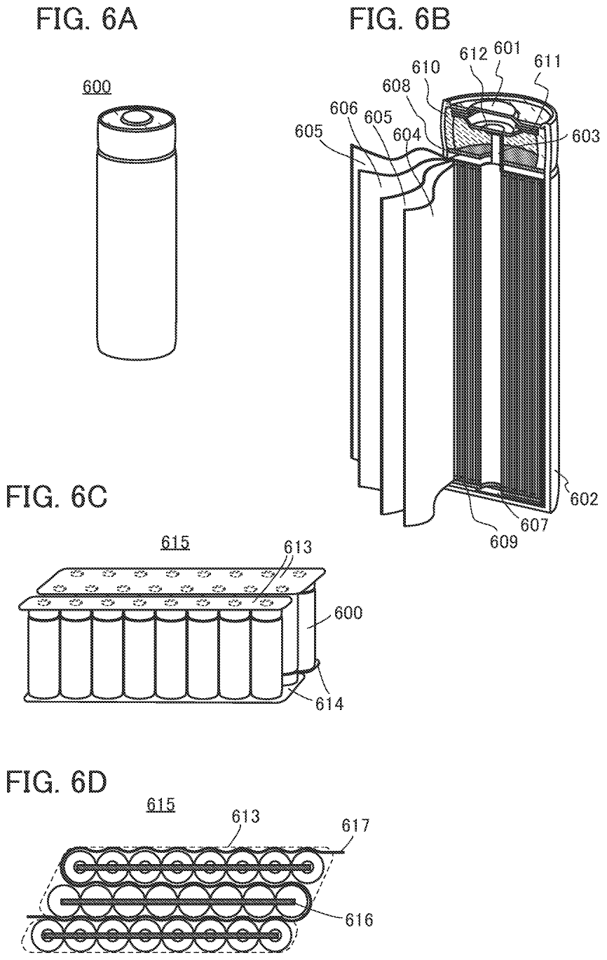

Next, an example of a cylindrical secondary battery is described with reference to FIG. 6. FIG. 6A is an external view of a cylindrical secondary battery 600. FIG. 6B is a diagram schematically illustrating a cross section of the cylindrical secondary battery 600. As illustrated in FIG. 6B, the cylindrical secondary battery 600 includes a positive electrode cap (battery lid) 601 on a top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte, a nonaqueous electrolyte that is similar to that for a coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC (Positive Temperature Coefficient) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 6C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 6D is atop view of the module 615. The conductive plate 613 is shown by a dotted line for clarity of the drawing. As illustrated in FIG. 6D, the module 615 may include a wiring 616 that electrically connects the plurality of secondary batteries 600 to each other. It is possible to provide the conductive plate over the wiring 616 to overlap each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### [Structure Examples of Secondary Battery]

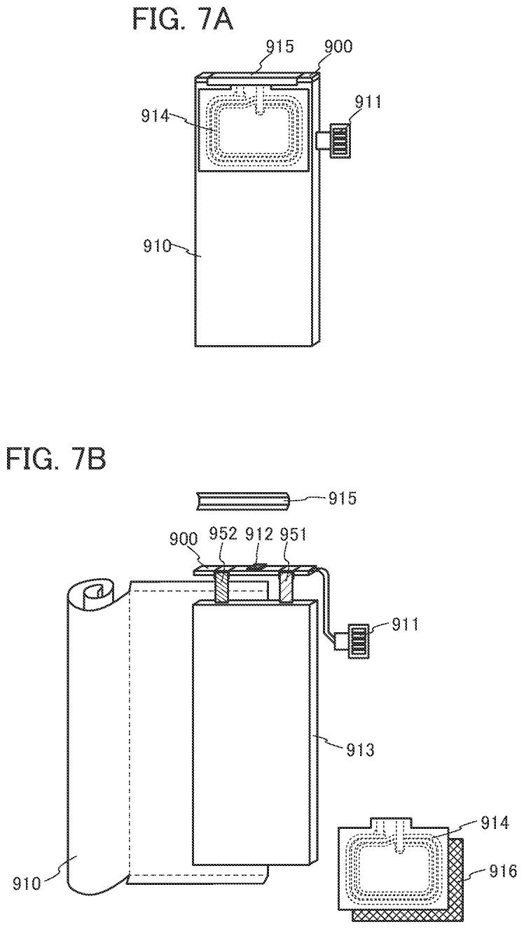

Other structure examples of secondary batteries are described using FIG. 7 to FIG. 11.

FIG. 7A and FIG. 7B are external views of a battery pack. The battery pack includes a circuit board 900 and a secondary battery 913. A label 910 is attached to the secondary battery 913. As illustrated in FIG. 7B, the secondary battery 913 includes a terminal 951 and a terminal 952. The circuit board 900 is fixed by a sealant 915.

The circuit board 900 includes a terminal 911 and a circuit 912. The terminal 911 is connected to the terminal 951, the terminal 952, an antenna 914, and the circuit 912 via the circuit board 900. Note that a plurality of terminals 911 may be provided to serve separately as a control signal input terminal, a power supply terminal, and the like.

The circuit 912 may be provided on the rear surface of the circuit board 900. Note that the shape of the antenna 914 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used.

Alternatively, the antenna 914 may be a flat-plate conductor. This flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field from the secondary battery 913, for example. For the layer 916, for example, a magnetic material can be used.

Note that the structure of the secondary battery is not limited to that in FIG. 7.

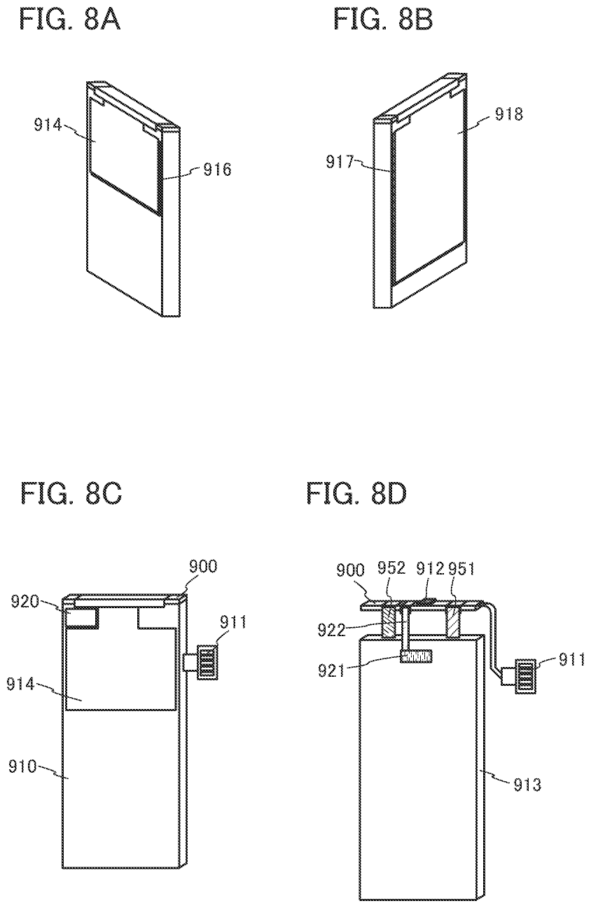

For example, as illustrated in FIG. 8A and FIG. 8B, an antenna may be provided for each of a pair of opposite surfaces of the secondary battery 913 illustrated in FIG. 7A and FIG. 7B. FIG. 8A is an external view illustrating one of the pair of surfaces, and FIG. 8B is an external view illustrating the other of the pair of surfaces. Note that for the same portions as those in FIG. 7A and FIG. 7B, the description of the secondary battery illustrated in FIG. 7A and FIG. 7B can be appropriately referred to.

As illustrated in FIG. 8A, the antenna 914 is provided on one of the pair of surfaces of the secondary battery 913 with the layer 916 located therebetween, and as illustrated in FIG. 8B, an antenna 918 is provided on the other of the pair of surfaces of the secondary battery 913 with a layer 917 located therebetween. The layer 917 has a function of blocking an electromagnetic field from the secondary battery 913, for example. For the layer 917, for example, a magnetic material can be used.

With the above structure, both of the antenna 914 and the antenna 918 can be increased in size. The antenna 918 has a function of communicating data with an external device, for example. An antenna with a shape that can be applied to the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 8C, the secondary battery 913 illustrated in FIG. 7A and FIG. 7B may be provided with a display device 920. The display device 920 is electrically connected to the terminal 911. Note that the label 910 is not necessarily provided in a portion where the display device 920 is provided. Note that for the same portions as those in FIG. 7A and FIG. 7B, the description of the secondary battery illustrated in FIG. 7A and FIG. 7B can be appropriately referred to.

The display device 920 may display, for example, an image showing whether or not charge is being carried out, an image showing the amount of stored power, or the like. As the display device 920, electronic paper, a liquid crystal display device, an electroluminescence (also referred to as EL) display device, or the like can be used, for example. For example, the use of electronic paper can reduce power consumption of the display device 920.

Alternatively, as illustrated in FIG. 8D, the secondary battery 913 illustrated in FIG. 7A and FIG. 7B may be provided with a sensor 921. The sensor 921 is electrically connected to the terminal 911 via a terminal 922. Note that for the same portions as those in FIG. 7A and FIG. 7B, the description of the secondary battery illustrated in FIG. 7A and FIG. 7B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment where the secondary battery is placed (e.g., temperature or the like) can be detected and stored in a memory inside the circuit 912.

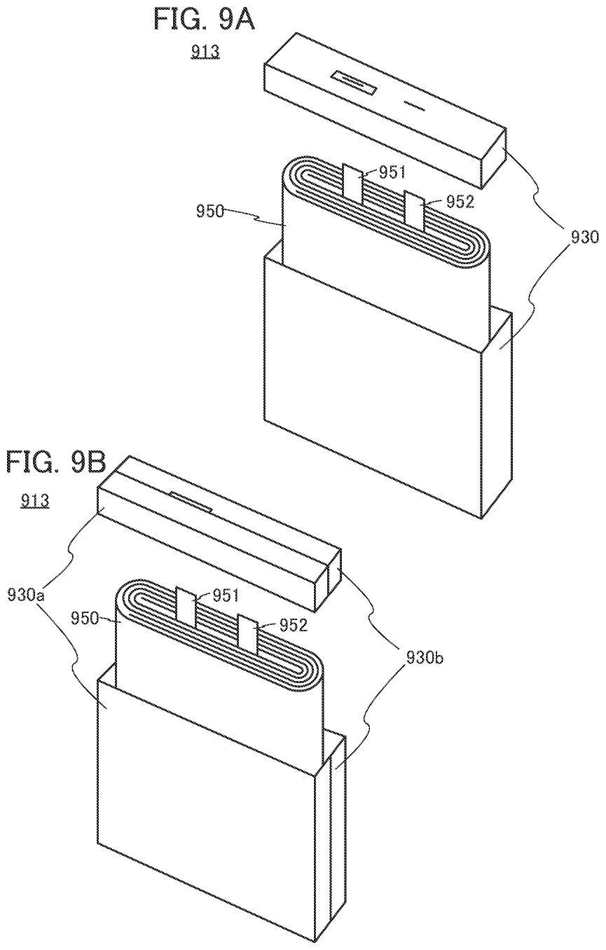

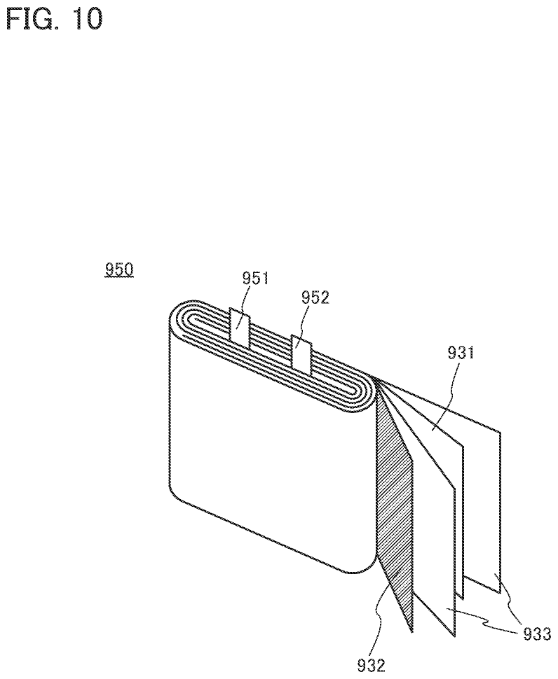

Furthermore, structure examples of the secondary battery 913 will be described with reference to FIG. 9 and FIG. 10.

The secondary battery 913 illustrated in FIG. 9A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that for convenience, FIG. 9A illustrates the housing 930 divided into pieces; however, in reality, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 9B, the housing 930 illustrated in FIG. 9A may be formed using a plurality of materials. For example, in the secondary battery 913 illustrated in FIG. 9B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna such as the antenna 914 may be provided inside the housing 930a. For the housing 930b, a metal material can be used, for example.

FIG. 10 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 provided therebetween. Note that a plurality of stacks each including the negative electrode 931, the positive electrode 932, and the separator 933 may be stacked. Note that a plurality of stacks of the negative electrode 931, the positive electrode 932, and the separator 933 may be overlaid.

The negative electrode 931 is connected to the terminal 911 illustrated in FIG. 7 via one of the terminal 951 and the terminal 952. The positive electrode 932 is connected to the terminal 911 illustrated in FIG. 7 via the other of the terminal 951 and the terminal 952.

When the positive electrode active material described in the above embodiment is used in the positive electrode 932, the secondary battery 913 with high capacity and excellent cycle performance can be obtained.

### [Laminated Secondary Battery]

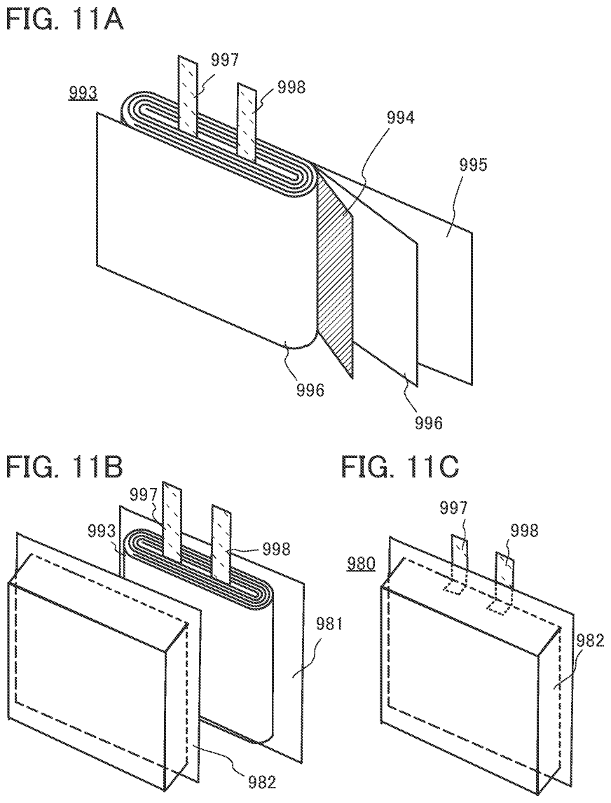

Next, an example of a laminated secondary battery will be described with reference to FIG. 11 to FIG. 17. When the laminated secondary battery has flexibility and is used in an electronic device at least part of which is flexible, the secondary battery can be bent as the electronic device is bent.

A laminated secondary battery 980 is described with reference to FIG. 11. The laminated secondary battery 980 includes a wound body 993 illustrated in FIG. 11A. The wound body 993 includes a negative electrode 994, a positive electrode 995, and separators 996. The wound body 993 is, like the wound body 950 illustrated in FIG. 10, obtained by winding a sheet of a stack in which the negative electrode 994 and the positive electrode 995 overlap with the separator 996 therebetween.

Note that the number of stacks including the negative electrode 994, the positive electrode 995, and the separator 996 is designed as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 11B, the wound body 993 is packed in a space formed through attachment of a film 981 serving as an exterior body and a film 982 having a depressed portion by thermocompression bonding or the like, whereby the secondary battery 980 can be manufactured as illustrated in FIG. 11C. The wound body 993 includes the lead electrode 997 and the lead electrode 998, and is immersed in an electrolyte solution inside a space surrounded by the film 981 and the film 982 having a depressed portion.

For the film 981 and the film 982 having a depressed portion, a metal material such as aluminum or a resin material can be used, for example. With the use of a resin material as the material of the film 981 and the film 982 having a depressed portion, the film 981 and the film 982 having a depressed portion can be deformed when external force is applied; thus, a flexible storage battery can be manufactured.

Although FIG. 11B and FIG. 11C illustrate an example of using two films, a space may be formed by bending one film and the wound body 993 may be packed in the space.

When the positive electrode active material described in the above embodiment is used in the positive electrode 995, the secondary battery 980 with high capacity and excellent cycle performance can be obtained.

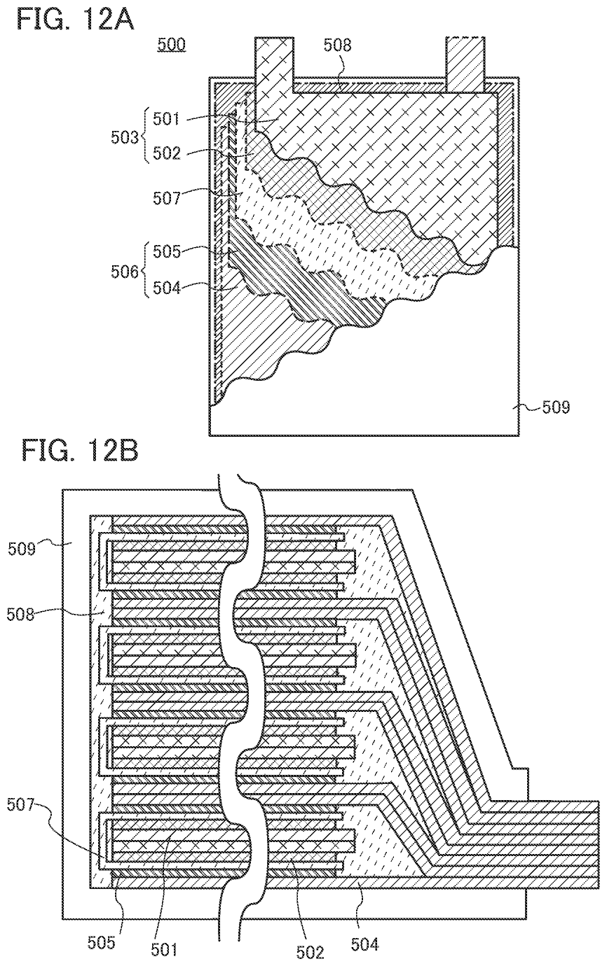

FIG. 11 illustrates an example in which the secondary battery 980 includes a wound body in a space formed by films serving as an exterior body; alternatively, as illustrated in FIG. 12, for example, a secondary battery may include a plurality of strip-shaped positive electrodes, separators, and negative electrodes in a space formed by films serving as an exterior body.

A laminated secondary battery 500 illustrated in FIG. 12A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 that are provided in the exterior body 509. The exterior body 509 is filled with the electrolyte solution 508. The electrolyte solution described in Embodiment 2 can be used as the electrolyte solution 508.

In the laminated secondary battery 500 illustrated in FIG. 12A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 12B shows an example of a cross-sectional structure of the laminated secondary battery 500. Although FIG. 12A illustrates an example in which the laminated secondary battery 500 is composed of two current collectors for simplicity, the laminated secondary battery 500 is actually composed of a plurality of electrode layers, as illustrated in FIG. 12B.

In FIG. 12B, the number of electrode layers is 16, for example. The laminated secondary battery 500 has flexibility even though including 16 electrode layers. FIG. 12B illustrates a structure including 8 layers of negative electrode current collectors 504 and 8 layers of positive electrode current collectors 501, i.e., 16 layers in total. Note that FIG. 12B illustrates a cross section of the lead portion of the negative electrode, and the 8 negative electrode current collectors 504 are bonded to each other by ultrasonic welding. It is needless to say that the number of electrode layers is not limited to 16 and may be either more than 16 or less than 16. In the case where the number of electrode layers is large, the secondary battery can have higher capacity. Meanwhile, in the case where the number of electrode layers is small, the secondary battery can have small thickness and high flexibility.

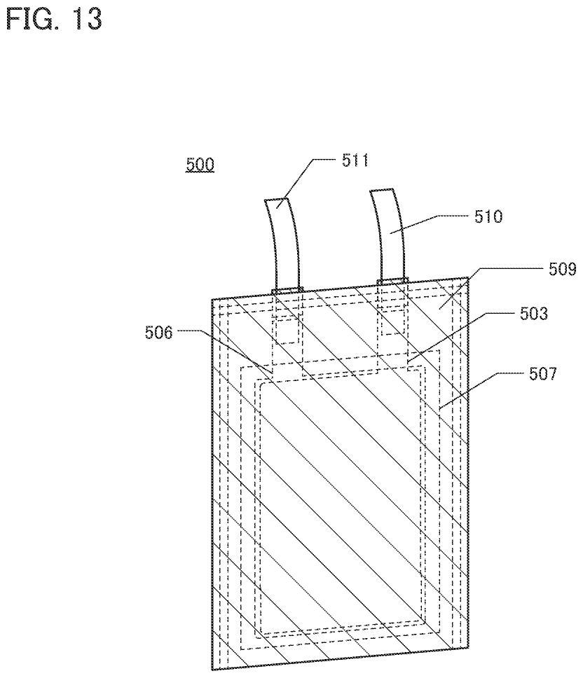

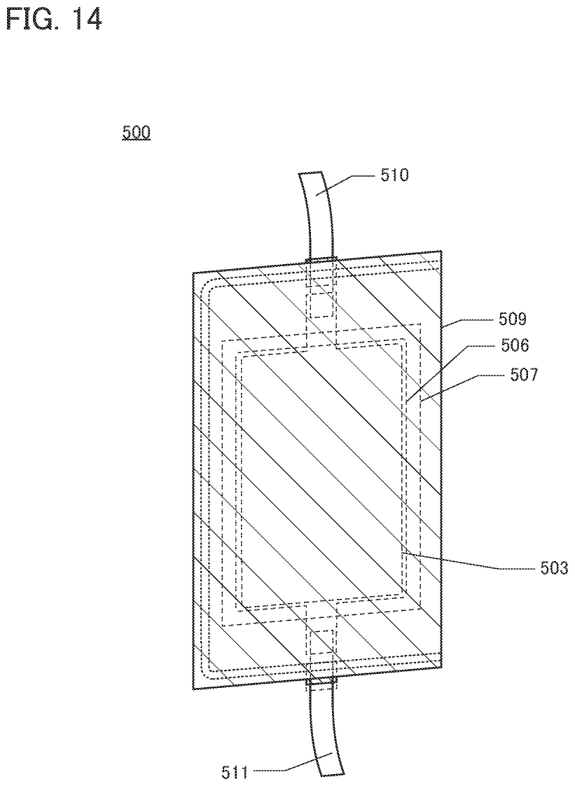

FIG. 13 and FIG. 14 each illustrate an example of the external view of the laminated secondary battery 500. In FIG. 13 and FIG. 14, the positive electrode 503, the negative electrode 506, the separator 507, the exterior body 509, a positive electrode lead electrode 510, and a negative electrode lead electrode 511 are included.

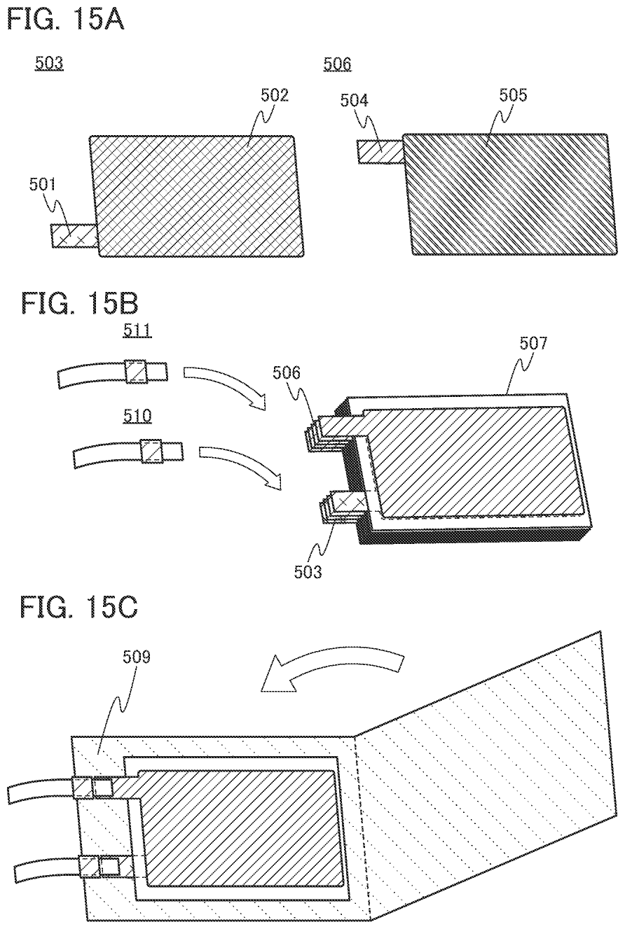

FIG. 15A shows external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 15A.

### [Method for Manufacturing Laminated Secondary Battery]

Here, an example of a method for manufacturing the laminated secondary battery whose external view is illustrated in FIG. 13 is described using FIG. 15B and FIG. 15C.

First, the negative electrode 506, the separator 507, and the positive electrode 503 are stacked. FIG. 15B illustrates the stack of the negative electrode 506, the separator 507, and the positive electrode 503. The secondary battery described here as an example includes five negative electrodes and four positive electrodes. Next, the tab regions of the positive electrodes 503 are bonded to each other, and a positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and a negative electrode lead electrode 511 is bonded to the tab region of the negative electrode on the outermost surface.

After that, the negative electrode 506, the separator 507, and the positive electrode 503 are placed over the exterior body 509.

Subsequently, the exterior body 509 is folded along a portion shown by a dashed line, as illustrated in FIG. 15C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be manufactured.

When the positive electrode active material described in the above embodiment is used in the positive electrode 503, the secondary battery 500 with high capacity and excellent cycle performance can be obtained.

### [Bendable Secondary Battery]

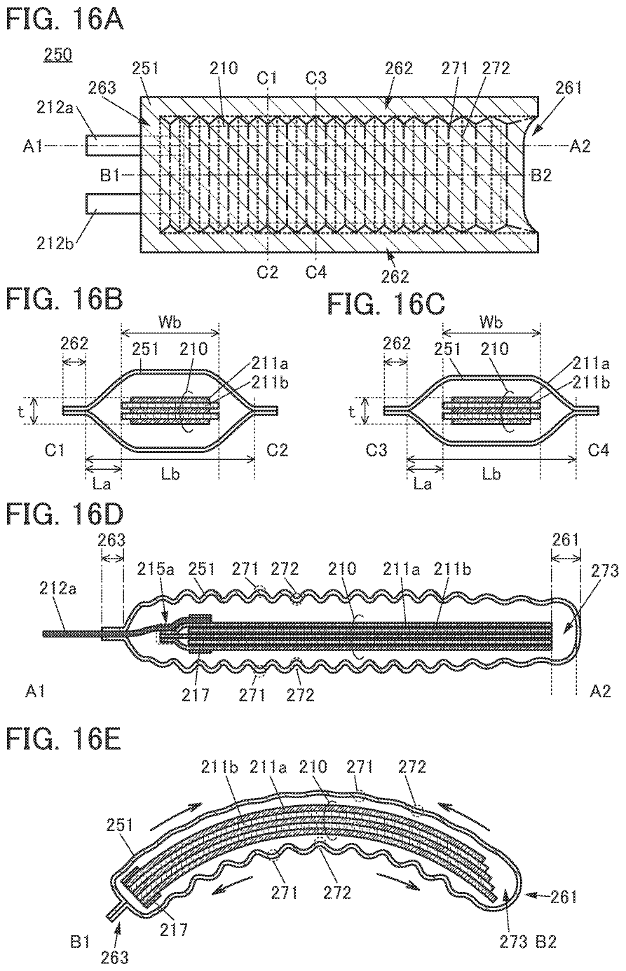

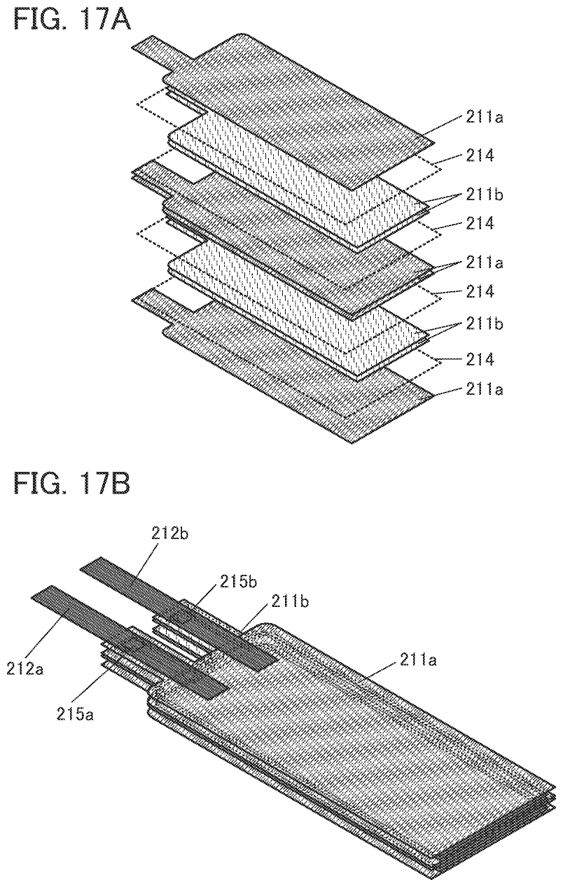

Next, an example of a bendable secondary battery is described with reference to FIG. 16 and FIG. 17.

FIG. 16A is a schematic top view of a bendable secondary battery 250. FIG. 16B, FIG. 16C, and FIG. 16D are schematic cross-sectional views along cutting line C1-C2, cutting line C3-C4, and cutting line A1-A2, respectively, in FIG. 16A. The secondary battery 250 includes an exterior body 251 and an electrode stack 210 held in the exterior body 251. The electrode stack 210 includes at least a positive electrode 211a and a negative electrode 211b. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

The positive electrode 211a and the negative electrode 211b that are included in the secondary battery 250 are described using FIG. 17. FIG. 17A is a perspective view illustrating the stacking order of the positive electrode 211a, the negative electrode 211b, and a separator 214. FIG. 17B is a perspective view illustrating the lead 212a and the lead 212b in addition to the positive electrode 211a and the negative electrode 211b.

As illustrated in FIG. 17A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab portion. A positive electrode active material layer is formed on a portion of one surface of the positive electrode 211a other than the tab portion, and a negative electrode active material layer is formed on a portion of one surface of the negative electrode 211b other than the tab portion.

The positive electrodes 211a and the negative electrodes 211b are stacked so that surfaces of the positive electrodes 211a on each of which the positive electrode active material layer is not formed are in contact with each other and surfaces of the negative electrodes 211b on each of which the negative electrode active material layer is not formed are in contact with each other.

The separator 214 is provided between the surface of the positive electrode 211a on which the positive electrode active material layer is formed and the surface of the negative electrode 211b on which the negative electrode active material layer is formed. In FIG. 17A, the separator 214 is shown by a dotted line for easy viewing.

As illustrated in FIG. 17B, the plurality of positive electrodes 211a are electrically connected to the lead 212a in a bonding portion 215a. Furthermore, the plurality of negative electrodes 211b are electrically connected to the lead 212b in a bonding portion 215b.

Next, the exterior body 251 is described using FIG. 16B, FIG. 16C, FIG. 16D, and FIG. 16E.

The exterior body 251 has a film-like shape and is folded in half with the positive electrodes 211a and the negative electrodes 211b between facing portions of the exterior body 251. The exterior body 251 includes a bent portion 261, a pair of seal portions 262, and a seal portion 263. The pair of seal portions 262 are provided with the positive electrodes 211a and the negative electrodes 211b positioned therebetween and can also be referred to as side seals. The seal portion 263 includes portions overlapping with the lead 212a and the lead 212b and can also be referred to as a top seal.

Portions of the exterior body 251 that overlap with the positive electrodes 211a and the negative electrodes 211b preferably have a wave shape in which crest lines 271 and trough lines 272 are alternately arranged. The seal portions 262 and the seal portion 263 of the exterior body 251 are preferably flat.

FIG. 16B shows a cross section cut along a portion overlapping with the crest line 271. FIG. 16C shows a cross section cut along a portion overlapping with the trough line 272. FIG. 16B and FIG. 16C correspond to cross sections of the secondary battery 250, the positive electrodes 211a, and the negative electrodes 211b in the width direction.

Here, the distance between end portions of the positive electrode 211a and the negative electrode 211b in the width direction, that is, the end portions of the positive electrode 211a and the negative electrode 211b, and the seal portion 262 is referred to as a distance La. When the secondary battery 250 changes in shape, for example, is bent, the positive electrode 211a and the negative electrode 211b change in shape such that positions thereof are shifted from each other in the length direction as described later. At the time, if the distance La is too short, the exterior body 251 rubs hard against the positive electrode 211a and the negative electrode 211b, so that the exterior body 251 is damaged in some cases. In particular, when a metal film of the exterior body 251 is exposed, the metal film might be corroded by the electrolyte solution. Therefore, the distance La is preferably set as long as possible. On the other hand, if the distance La is too long, the volume of the secondary battery 250 is increased.

The distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is indicated by t, the distance La is 0.8 times or more and 3.0 times or less, preferably 0.9 times or more and 2.5 times or less, further preferably 1.0 time or more and 2.0 times or less as large as the thickness t. When the distance La is in this range, a compact battery that is highly reliable for bending can be achieved.

Furthermore, when the distance between the pair of seal portions 262 is indicated by a distance Lb, it is preferable that the distance Lb be sufficiently larger than the widths of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; hence, the positive electrode 211a and the negative electrode 211b can be effectively prevented from rubbing against the exterior body 251.

For example, the difference between the distance Lb between the pair of seal portions 262 and the width Wb of the negative electrode 211b is preferably 1.6 times or more and 6.0 times or less, further preferably 1.8 times or more and 5.0 times or less, still further preferably 2.0 times or more and 4.0 times or less as large as the thickness t of the positive electrode 211a and the negative electrode 211b.

FIG. 16D shows a cross section including the lead 212a and corresponds to a cross section of the secondary battery 250, the positive electrode 211a, and the negative electrode 211b in the length direction. As illustrated in FIG. 16D, in the bent portion 261, a space 273 is preferably included between the end portions of the positive electrode 211a and the negative electrode 211b in the length direction and the exterior body 251.

FIG. 16E is a schematic cross-sectional view of the secondary battery 250 that is bent. FIG. 16E corresponds to a cross section along cutting line B1-B2 in FIG. 16A.

When the secondary battery 250 is bent, the exterior body 251 is deformed such that a part positioned on the outer side of bending expands and another part positioned on the inner side of bending shrinks. Specifically, a portion of the exterior body 251 that is positioned on the outer side is deformed such that the wave amplitude becomes smaller and the wave period becomes longer. By contrast, a portion of the exterior body 251 that is positioned on the inner side is deformed such that the wave amplitude becomes larger and the wave period becomes shorter. When the exterior body 251 is deformed in this manner, stress applied to the exterior body 251 due to bending is relieved, so that a material itself of the exterior body 251 does not need to expand and shrink. As a result, the secondary battery 250 can be bent with weak force without damage to the exterior body 251.

As illustrated in FIG. 16E, when the secondary battery 250 is bent, the positive electrode 211a and the negative electrode 211b are shifted relatively to each other. At this time, ends of the stacked positive electrodes 211a and negative electrodes 211b on the seal portion 263 side are fixed by a fixing member 217. Thus, the positive electrodes 211a and the negative electrodes 211b are shifted so that the shift amount becomes larger at a position closer to the bent portion 261. Therefore, stress applied to the positive electrodes 211a and the negative electrodes 211b is relieved, and the positive electrodes 211a and the negative electrodes 211b themselves do not need to expand and shrink. Consequently, the secondary battery 250 can be bent without damage to the positive electrodes 211a and the negative electrodes 211b.

Furthermore, the space 273 is included between the positive electrode 211a and the negative electrode 211b, and the exterior body 251, whereby the positive electrode 211a and the negative electrode 211b can be shifted relatively while the positive electrode 211a and the negative electrode 211b located on the inner side in bending do not come into contact with the exterior body 251.

In the secondary battery 250 illustrated in FIG. 16 and FIG. 17, the exterior body, the positive electrode 211a, and the negative electrode 211b are less likely to be damaged and the battery characteristics are less likely to deteriorate even when the secondary battery 250 is repeatedly bent and unbent. When the positive electrode active material described in the above embodiment is used in the positive electrode 211a included in the secondary battery 250, a battery with better cycle performance can be obtained.

### Embodiment 4

In this embodiment, examples of electronic devices each including the secondary battery of one embodiment of the present invention will be described.

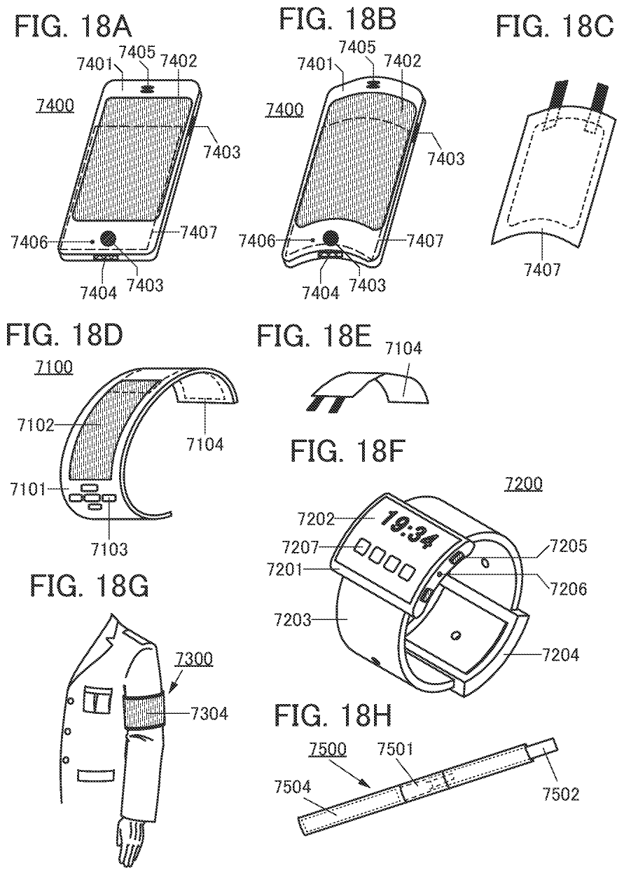

First, FIG. 18A to FIG. 18G show examples of electronic devices each including the bendable secondary battery described in part of Embodiment 3. Examples of electronic devices each including the bendable secondary battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

A secondary battery with a flexible shape can also be incorporated along a curved surface of an inside wall or an outside wall of a house or a building or an interior or an exterior of an automobile.

FIG. 18A illustrates an example of a mobile phone. A mobile phone 7400 includes an operation button 7403, an external connection port 7404, a speaker 7405, a microphone 7406, and the like in addition to a display portion 7402 incorporated in a housing 7401. Note that the mobile phone 7400 includes a secondary battery 7407. With the use of the secondary battery of one embodiment of the present invention as the secondary battery 7407, a lightweight mobile phone with a long lifetime can be provided.

FIG. 18B shows the state where the mobile phone 7400 is curved. When the whole mobile phone 7400 is curved through deformation by external force, the secondary battery 7407 provided therein is also curved. FIG. 18C shows the bent secondary battery 7407. The secondary battery 7407 is a thin storage battery. The secondary battery 7407 is fixed in a state of being bent. Note that the secondary battery 7407 includes a lead electrode electrically connected to a current collector. For example, the current collector is copper foil and is partly alloyed with gallium to improve adhesion between the current collector and an active material layer in contact with the current collector, and the secondary battery 7407 has high reliability in a state of being bent.

FIG. 18D illustrates an example of a bangle-type display device. A portable display device 7100 includes a housing 7101, a display portion 7102, operation buttons 7103, and a secondary battery 7104. FIG. 18E shows the bent secondary battery 7104. When the display device is worn on a user's arm while the secondary battery 7104 is bent, the housing changes in shape and the curvature of part or the whole of the secondary battery 7104 is changed. Note that a value represented by the radius of a circle that corresponds to the bending condition of a curve at a given point is referred to as the radius of curvature, and the reciprocal of the radius of curvature is referred to as curvature. Specifically, part or the whole of the housing or the main surface of the secondary battery 7104 is changed with a radius of curvature in the range of 40 mm to 150 mm. When the radius of curvature of the main surface of the secondary battery 7104 is within the range of 40 mm to 150 mm, reliability can be kept high. With the use of the secondary battery of one embodiment of the present invention as the secondary battery 7104, a lightweight portable display device with a long lifetime can be provided.

FIG. 18F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can employ near field communication based on an existing communication standard. For example, mutual communication with a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight portable information terminal with a long lifetime can be provided. For example, the secondary battery 7104 shown in FIG. 18E that is in the state of being curved can be provided in the housing 7201. Alternatively, the secondary battery 7104 shown in FIG. 18E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, an acceleration sensor, or the like is preferably mounted.

FIG. 18G illustrates an example of an armband display device. A display device 7300 includes a display portion 7304 and the secondary battery of one embodiment of the present invention. The display device 7300 can further include a touch sensor in the display portion 7304 and can also serve as a portable information terminal.

The display surface of the display portion 7304 is curved, and display can be performed on the curved display surface. In addition, the display state of the display device 7300 can be changed by, for example, near field communication based on an existing communication standard.

The display device 7300 includes an input/output terminal, and data can be directly transmitted to and received from another information terminal via a connector. In addition, charging via the input/output terminal is also possible. Note that the charging operation may be performed by wireless power feeding without using the input/output terminal.

With the use of the secondary battery of one embodiment of the present invention as the secondary battery included in the display device 7300, a lightweight display device with a long lifetime can be provided.

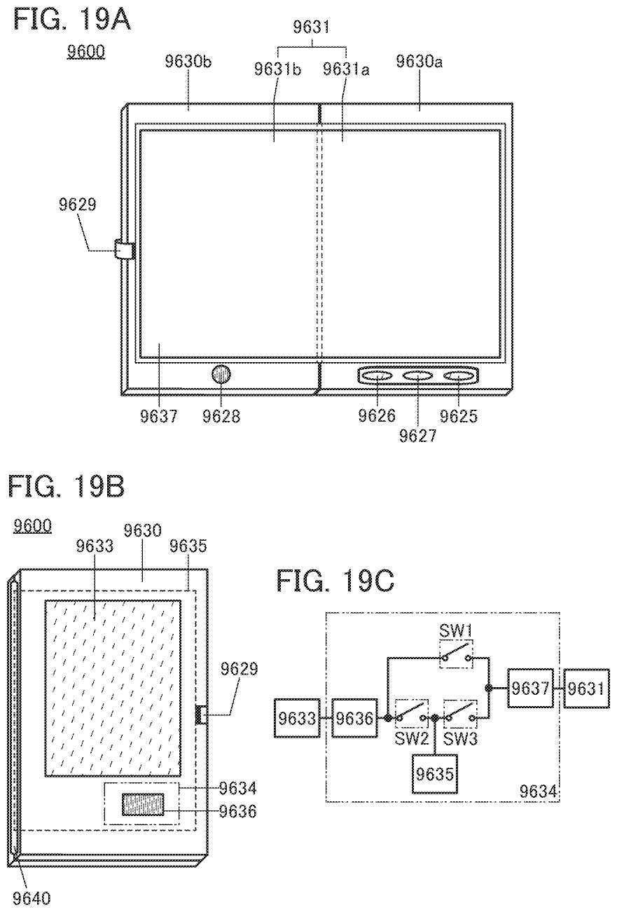

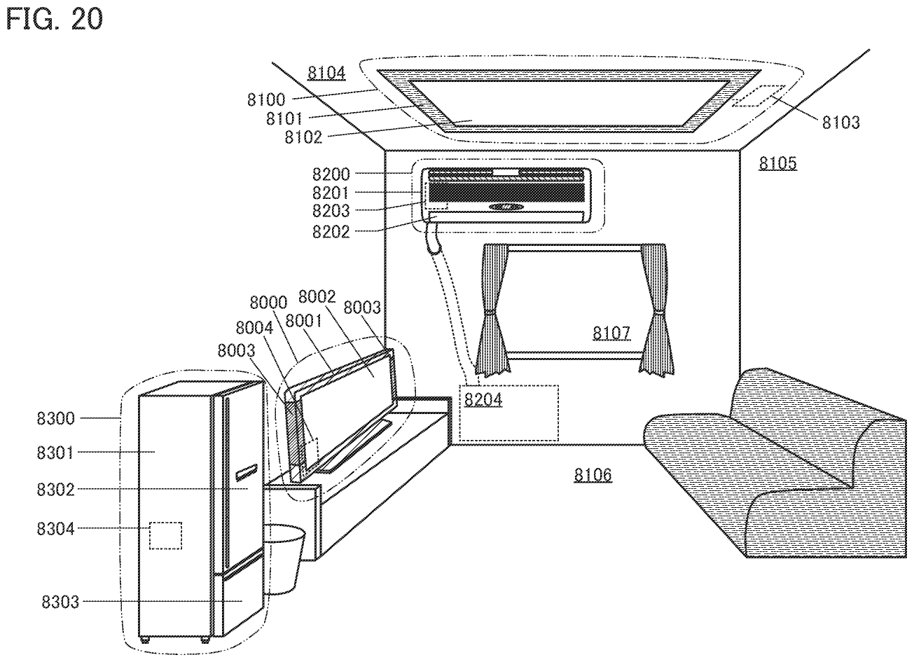

Examples of electronic devices each including the secondary battery with excellent cycle performance described in the above embodiment will be described using FIG. 18H, FIG. 19, and FIG. 20.

With the use of the secondary battery of one embodiment of the present invention as a secondary battery of a daily electronic device, a lightweight product with a long lifetime can be provided. Examples of the daily electronic device include an electric toothbrush, an electric shaver, and electric beauty equipment. As secondary batteries of these products, small and lightweight secondary batteries with stick-like shapes and high capacity are desired in consideration of handling ease for users.

FIG. 18H is a perspective view of a device called a vaporizer (electronic cigarette). In FIG. 18H, an electronic cigarette 7500 includes an atomizer 7501 including a heating element, a secondary battery 7504 that supplies electric power to the atomizer, and a cartridge 7502 including a liquid supply bottle, a sensor, and the like. To increase safety, a protection circuit that prevents overcharge and overdischarge of the secondary battery 7504 may be electrically connected to the secondary battery 7504. The secondary battery 7504 illustrated in FIG. 18H includes an external terminal to be connected to a charger. When the electronic cigarette 7500 is held, the secondary battery 7504 is a tip portion; thus, it is desirable that the secondary battery 7504 have a short total length and be lightweight. Since the secondary battery of one embodiment of the present invention has high capacity and excellent cycle performance, the small and lightweight electronic cigarette 7500 that can be used for a long time over a long period can be provided.

Next, FIG. 19A and FIG. 19B illustrate an example of a foldable tablet terminal. A tablet terminal 9600 illustrated in FIG. 19A and FIG. 19B includes a housing 9630a, a housing 9630b, a movable portion 9640 that connects the housing 9630a to the housing 9630b, a display portion 9631 that includes a display portion 9631a and a display portion 9631b, a switch 9625, a switch 9626, a switch 9627, a fastener 9629, and an operation switch 9628. A flexible panel is used for the display portion 9631, whereby a tablet terminal having a larger display portion can be provided. FIG. 19A illustrates the tablet terminal 9600 that is opened, and FIG. 19B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

Part of or the entire display portion 9631 can be a touch panel region, and data can be input by touching an image including an icon, text, an input form, and the like displayed on the region. For example, keyboard buttons may be displayed on the entire surface of the display portion 9631a on the housing 9630a side, and data such as text or an image may be displayed on the display portion 9631b on the housing 9630b side.

Alternatively, a keyboard may be displayed on the display portion 9631b on the housing 9630b side, and data such as text or an image may be displayed on the display portion 9631a on the housing 9630a side. Alternatively, a button for switching keyboard display on a touch panel may be displayed on the display portion 9631, and the button may be touched with a finger, a stylus, or the like to display a keyboard on the display portion 9631.

Touch input can also be performed concurrently in a touch panel region in the display portion 9631a on the housing 9630a side and a touch panel region in the display portion 9631b on the housing 9630b side.

The switch 9625 to the switch 9627 may function not only as interfaces for operating the tablet terminal 9600 but also as interfaces that can switch various functions. For example, at least one of the switch 9625 to the switch 9627 may function as a switch for switching power on/off of the tablet terminal 9600. As another example, at least one of the switch 9625 to the switch 9627 may have a function of switching display between a portrait mode and a landscape mode or a function of switching display between monochrome display and color display. As another example, at least one of the switch 9625 to the switch 9627 may have a function of adjusting the luminance of the display portion 9631. Alternatively, the luminance of the display portion 9631 can be optimized in accordance with the amount of external light in use of the tablet terminal 9600, which is detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 19A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different areas or different display quality. For example, one may be a display panel that can display higher-definition images than the other.

The tablet terminal 9600 is folded in half in FIG. 19B. The tablet terminal 9600 includes a housing 9630, a solar cell 9633, and a charge and discharge control circuit 9634 including a DCDC converter 9636. A power storage unit of one embodiment of the present invention is used as the power storage unit 9635.

Note that as described above, the tablet terminal 9600 can be folded in half; thus, the tablet terminal 9600 can be folded such that the housing 9630a and the housing 9630b overlap each other when not in use. The display portion 9631 can be protected owing to the folding, which increases the durability of the tablet terminal 9600. Since the power storage unit 9635 including the secondary battery of one embodiment of the present invention has high capacity and excellent cycle performance, the tablet terminal 9600 that can be used for a long time over a long period can be provided.

The tablet terminal 9600 illustrated in FIG. 19A and FIG. 19B can also have a function of displaying various kinds of data (e.g., a still image, a moving image, and a text image), a function of displaying a calendar, the date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, supplies electric power to the touch panel, the display portion, a video signal processing portion, and the like. Note that the solar cell 9633 can be provided on one surface or both surfaces of the housing 9630, and the power storage unit 9635 can be charged efficiently. Note that the use of a lithium-ion battery as the power storage unit 9635 brings an advantage such as a reduction in size.

The structure and operation of the charge and discharge control circuit 9634 illustrated in FIG. 19B are described using a block diagram in FIG. 19C. FIG. 19C illustrates the solar cell 9633, the power storage unit 9635, the DCDC converter 9636, a converter 9637, switches SW1, SW2, and SW3, and the display portion 9631. The power storage unit 9635, the DCDC converter 9636, the converter 9637, and the switches SW1 to SW3 correspond to the charge and discharge control circuit 9634 illustrated in FIG. 19B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, SW1 is turned off and SW2 is turned on to charge the power storage unit 9635.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives electric power wirelessly (without contact) for charging, or with a combination of other charge units.

FIG. 20 illustrates other examples of electronic devices. In FIG. 20, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided inside the housing 8001. The display device 8000 can receive electric power from a commercial power supply and can use electric power stored in the secondary battery 8004. Thus, the display device 8000 can be utilized with the use of the secondary battery 8004 of one embodiment of the present invention as an uninterruptible power supply even when electric power cannot be supplied from a commercial power supply due to a power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement display, and the like besides for TV broadcast reception.

In FIG. 20, an installation lighting device 8100 is an example of an electronic device using a secondary battery 8103 of one embodiment of the present invention. Specifically, the lighting device 8100 includes a housing 8101, a light source 8102, the secondary battery 8103, and the like. Although FIG. 20 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply and can use electric power stored in the secondary battery 8103. Thus, the lighting device 8100 can be utilized with the use of the secondary battery 8103 of one embodiment of the present invention as an uninterruptible power supply even when electric power cannot be supplied from a commercial power supply due to a power failure or the like.

Note that although the installation lighting device 8100 provided in the ceiling 8104 is illustrated in FIG. 20 as an example, the secondary battery of one embodiment of the present invention can be used in an installation lighting device provided in, for example, a sidewall 8105, a floor 8106, a window 8107, or the like other than the ceiling 8104. Alternatively, the secondary battery can be used in a tabletop lighting device or the like.

As the light source 8102, an artificial light source that emits light artificially by using electric power can be used. Specific examples of the artificial light source include an incandescent lamp, a discharge lamp such as a fluorescent lamp, and light-emitting elements such as an LED and an organic EL element.

In FIG. 20, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 20 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply and can use electric power stored in the secondary battery 8203. Particularly in the case where the secondary batteries 8203 are provided in both the indoor unit 8200 and the outdoor unit 8204, the air conditioner can be utilized with the use of the secondary batteries 8203 of one embodiment of the present invention as uninterruptible power supplies even when electric power cannot be supplied from a commercial power supply due to a power failure or the like.

Note that although the split-type air conditioner including the indoor unit and the outdoor unit is illustrated in FIG. 20 as an example, the secondary battery of one embodiment of the present invention can also be used in an air conditioner in which the functions of an indoor unit and an outdoor unit are integrated in one housing.

In FIG. 20, an electric refrigerator-freezer 8300 is an example of an electronic device using a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 20. The electric refrigerator-freezer 8300 can receive electric power from a commercial power supply and can use electric power stored in the secondary battery 8304. Thus, the electric refrigerator-freezer 8300 can be utilized with the use of the secondary battery 8304 of one embodiment of the present invention as an uninterruptible power supply even when electric power cannot be supplied from a commercial power supply due to a power failure or the like.

Note that a high-frequency heating apparatus such as a microwave oven and an electronic device such as an electric rice cooker require high power in a short time. Therefore, the tripping of a breaker of a commercial power supply in use of such an electronic device can be prevented by using the secondary battery of one embodiment of the present invention as an auxiliary power supply for supplying electric power which cannot be supplied enough by the commercial power supply.

In addition, in a time period when electronic devices are not used, particularly when the proportion of the amount of electric power that is actually used to the total amount of electric power that can be supplied from a commercial power supply source (such a proportion is referred to as a usage rate of electric power) is low, electric power is stored in the secondary battery, whereby the usage rate of electric power can be reduced in a time period other than the above time period. For example, in the case of the electric refrigerator-freezer 8300, electric power is stored in the secondary battery 8304 in night time when the temperature is low and the refrigerator door 8302 and the freezer door 8303 are not opened and closed. On the other hand, in daytime when the temperature is high and the refrigerator door 8302 and the freezer door 8303 are opened and closed, the secondary battery 8304 is used as an auxiliary power supply; thus, the usage rate of electric power in daytime can be reduced.

According to one embodiment of the present invention, the cycle performance of the secondary battery can be made better and reliability can be improved. Furthermore, according to one embodiment of the present invention, a secondary battery with high capacity can be obtained; thus, the secondary battery itself can be made more compact and lightweight owing to the improvement in the characteristics of the secondary battery. Thus, the secondary battery of one embodiment of the present invention is incorporated in the electronic device described in this embodiment, whereby a more lightweight electronic device with a longer lifetime can be obtained.

This embodiment can be implemented in appropriate combination with the other embodiments.

### Embodiment 5

In this embodiment, examples of vehicles each including the secondary battery of one embodiment of the present invention will be described.

The use of secondary batteries in vehicles enables production of next-generation clean energy vehicles such as hybrid electric vehicles (HEVs), electric vehicles (EVs), and plug-in hybrid electric vehicles (PHEVs).

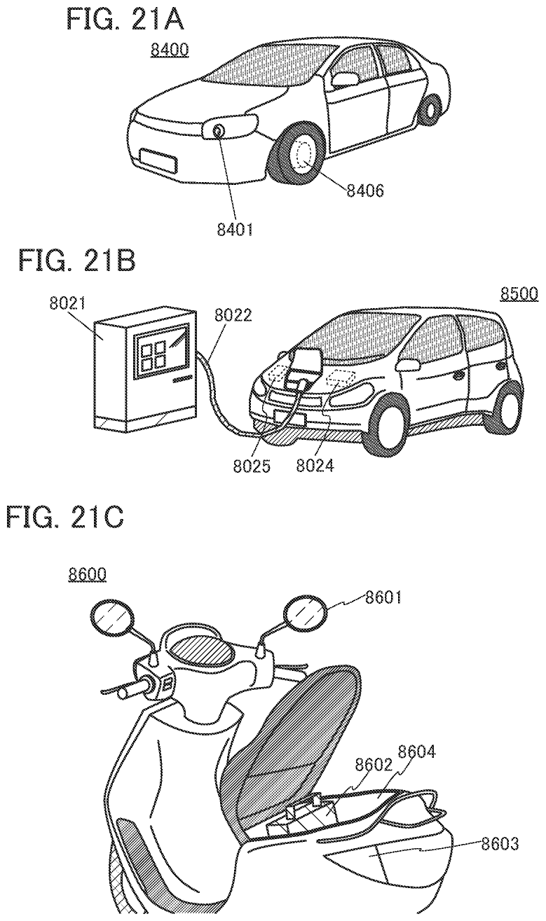

FIG. 21 illustrates examples of vehicles using the secondary battery of one embodiment of the present invention. An automobile 8400 illustrated in FIG. 21A is an electric vehicle that runs on the power of an electric moto as a power source. Alternatively, the automobile 8400 is a hybrid electric vehicle capable of driving appropriately using either an electric motor or an engine. The use of a secondary battery of one embodiment of the present invention can provide a high-mileage vehicle. In addition, the automobile 8400 includes a secondary battery. As the secondary battery, the modules of the secondary batteries illustrated in FIG. 6C and FIG. 6D can be arranged to be used in a floor portion in the automobile. Alternatively, a battery pack in which a plurality of secondary batteries illustrated in FIG. 9 are combined may be placed in the floor portion in the automobile. The secondary battery not only drives an electric motor 8406 but also can supply electric power to a light-emitting device such as a headlight 8401 or a room light (not illustrated).

In addition, the secondary battery can supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 21B can be charged when a secondary battery included in the automobile 8500 is supplied with electric power from external charging equipment by a plug-in system, a contactless power feeding system, or the like. FIG. 21B illustrates a state where a secondary battery 8024 incorporated in the automobile 8500 is charged from a ground-based charging device 8021 through a cable 8022. Charging can be performed as appropriate by a given method such as CHAdeMO (registered trademark) or Combined Charging System as a charging method, the standard of a connector, or the like. The charging device 8021 may be a charging station provided in a commerce facility or a power source in a house. For example, with a plug-in technique, the secondary battery 8024 and a secondary battery 8025 incorporated in the automobile 8500 can be charged by power supply from the outside. The charging can be performed by converting AC electric power into DC electric power through a converter, such as an ACDC converter.

Although not illustrated, the vehicle may include a power-receiving device so that it can be charged by being supplied with electric power from an aboveground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery while the vehicle is stopped or driven. To supply electric power in such a contactless manner, an electromagnetic induction method or a magnetic resonance method can be used.

FIG. 21C shows an example of a motorcycle using the secondary battery of one embodiment of the present invention. A motor scooter 8600 illustrated in FIG. 21C includes a secondary battery 8602, side mirrors 8601, and direction indicators 8603. The secondary battery 8602 can supply electricity to the direction indicators 8603.

In the motor scooter 8600 illustrated in FIG. 21C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 can be carried indoors when charged, and can be stored before the motor scooter is driven.

According to one embodiment of the present invention, the cycle performance of the secondary battery can be made better, and the capacity of the secondary battery can be increased. Thus, the secondary battery itself can be made more compact and lightweight. When the secondary battery itself can be made more compact and lightweight, it contributes to a reduction in the weight of a vehicle, and thus can improve the cruising range. Furthermore, the secondary battery incorporated in the vehicle can also be used as a power supply source for devices other than the vehicle. In that case, the use of a commercial power supply can be avoided at peak time of power demand, for example. Avoiding the use of a commercial power supply at peak time of power demand can contribute to energy saving and a reduction in carbon dioxide discharge. Moreover, with excellent cycle performance, the secondary battery can be used over a long period; hence, the use amount of rare metal including cobalt can be reduced.

This embodiment can be implemented in appropriate combination with the other embodiments.

### Embodiment 6

This embodiment will describe examples of wearable devices that can include a secondary battery containing the positive electrode active material of one embodiment of the present invention.

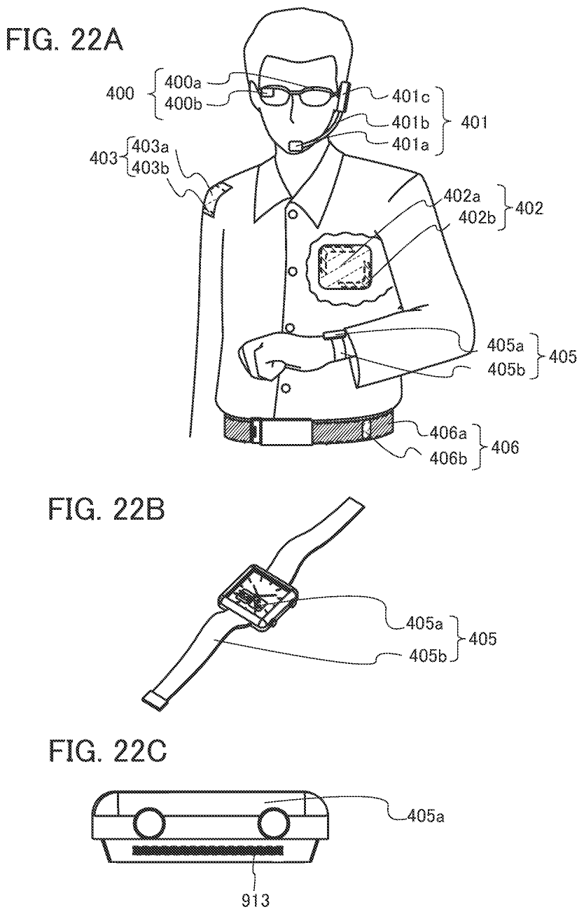

FIG. 22A illustrates examples of wearable devices. A secondary battery is used as a power source of a wearable device. To have improved water resistance in daily use or outdoor use by a user, a wearable device is desirably capable of being charged wirelessly as well as being charged with a wire whose connector portion for connection is exposed.

For example, a secondary battery can be incorporated in a glasses-type device 400 illustrated in FIG. 22A. The glasses-type device 400 includes a frame 400a and a display portion 400b. The secondary battery is provided in a temple of the frame 400a having a curved shape, whereby the glasses-type device 400 can be lightweight, have a well-balanced weight, and be used continuously for a long time.

Furthermore, a secondary battery can be incorporated in a headset-type device 401. The headset-type device 401 includes at least a microphone portion 401a, a flexible pipe 401b, and an earphone portion 401c. A secondary battery can be provided in the flexible pipe 401b or the earphone portion 401c.

A secondary battery can also be provided in a device 402 that can be directly attached to a human body. A secondary battery 402b can be provided in a thin housing 402a of the device 402.

A secondary battery can also be provided in a device 403 that can be attached to clothing. A secondary battery 403b can be provided in a thin housing 403a of the device 403.

A secondary battery can also be provided in a belt-type device 406. The belt-type device 406 includes a belt portion 406a and a wireless power feeding and receiving portion 406b, and the secondary battery can be included inside the belt portion 406a.

A secondary battery can also be provided in a watch-type device 405. The watch-type device 405 includes a display portion 405a and a belt portion 405b, and the secondary battery can be provided in the display portion 405a or the belt portion 405b.

The display portion 405a can display various kinds of information such as reception information of an e-mail or an incoming call in addition to the time.

Since the watch-type device 405 is a type of wearable device that is directly wrapped around an arm, a sensor that measures pulse, blood pressure, or the like of a user may be provided therein. Data on the exercise quantity and health of the user can be stored to be used for health maintenance.

The watch-type device 405 illustrated in FIG. 22A is described in detail below.

FIG. 22B is a perspective view of the watch-type device 405 that is detached from an arm.

FIG. 22C is a side view. FIG. 22C illustrates a state where the secondary battery 913 is incorporated in the watch-type device 405. The secondary battery 913 is provided to overlap with the display portion 405a and is small and lightweight.

This embodiment can be implemented in appropriate combination with the other embodiments.

### Example 11

In this example, a secondary battery was fabricated using the positive electrode active material of one embodiment of the present invention and evaluated.

<Fabrication of positive electrode active material>

With reference to the manufacturing procedure shown in FIG. 3, Sample 1, Sample 2, Sample 3, and Sample 4 that were positive electrode active materials were fabricated.

First, the mixture 902 containing magnesium and fluorine was formed (Step S11 to Step S14). LiF and MgF₂ were weighted so that the molar ratio of LiF to MgF₂ was LiF:MgF₂=1:3, acetone was added as a solvent, and the materials were mixed and ground by a wet process. The mixing and the grinding were performed in a ball mill using a zirconia ball at 400 rpm for 12 hours. The material that has been subjected to the treatment was collected to be the mixture 902.

Next, nickel hydroxide, which is a metal source, and acetone were mixed to form pulverized nickel hydroxide (Step S15 to Step S17).

Then, for Sample 1 and Sample 2, aluminum fluoride, which is a metal source, and acetone were mixed to form pulverized aluminum fluoride (Step S18 to Step S20). Meanwhile, for Sample 3 and Sample 4, aluminum hydroxide was used as a metal source instead of aluminum fluoride to form pulverized aluminum hydroxide.

Next, lithium cobalt oxide was prepared as a composite oxide containing lithium and cobalt. Specifically, CELLSEED C-10N manufactured by NIPPON CHEMICAL INDUSTRIAL CO., LTD. was prepared (Step S25).

Then, in Step S31, the mixture 902, the nickel hydroxide, the aluminum fluoride or the aluminum hydroxide, and the lithium cobalt oxide were mixed. The composition was such that the number of moles of lithium in the mixture 902 was 0.0033 times, the number of moles of nickel in the nickel hydroxide was 0.005 times, and the number of moles of aluminum in the aluminum fluoride or the aluminum hydroxide was 0.005 times the number of moles of the lithium cobalt oxide. The mixing was performed by a dry method. The mixing was performed in a ball mill using a zirconia ball at 150 rpm for 1 hour.

Subsequently, the material that has been subjected to the treatment was collected to obtain the mixtures 903 (Step S32 and Step S33).

Next, the mixture 903 was put in an aluminum oxide crucible and annealed at 900° C. using a muffle furnace in an oxygen atmosphere for 20 hours (Step S34).

The amount of the mixture 903 subjected to the annealing was 30 g for Sample 1, 2.4 g for Sample 2, 30 g for Sample 3, and 2.4 g for Sample 4.

At the time of the annealing, the aluminum oxide crucible was covered with a lid. The flow rate of oxygen was 10 L/min. The temperature rise rate was 200° C./hr, and it took longer than or equal to 10 hours to lower the temperature. The material subjected to the heat treatment was collected and sifted (Step S35), and Sample 1, Sample 2, Sample 3, and Sample 4, each of which was the positive electrode active material, were obtained (Step S36).

### <Fabrication of Secondary Battery>

CR2032 (diameter: 20 mm, height: 3.2 mm) coin-type secondary batteries were fabricated using Sample 1, Sample 2, Sample 3, and Sample 4 as the positive electrode active material.

The positive electrodes were formed in such a manner that Sample 1, Sample 2, Sample 3, and Sample 4 fabricated as above were used as the positive electrode active material, and slurry was formed by mixing the positive electrode active material, acetylene black (AB), and polyvinylidene fluoride (PVDF) at the positive electrode active material:AB:PVDF=95:3:2 (weight ratio) and applied to current collectors.

A lithium metal was used for a counter electrode.

As an electrolyte contained in an electrolyte solution, 1 mol/L lithium hexafluorophosphate (LiPF₆) was used, and as the electrolyte solution, an electrolyte solution in which ethylene carbonate (EC) and diethyl carbonate (DEC) at EC:DEC=3:7 (volume ratio) and vinylene carbonate (VC) at 2 wt % were mixed was used.

As a separator, 25-μm-thick polypropylene was used.

A positive electrode can and a negative electrode can that were formed using stainless steel (SUS) were used.

### <Cycle Performance>

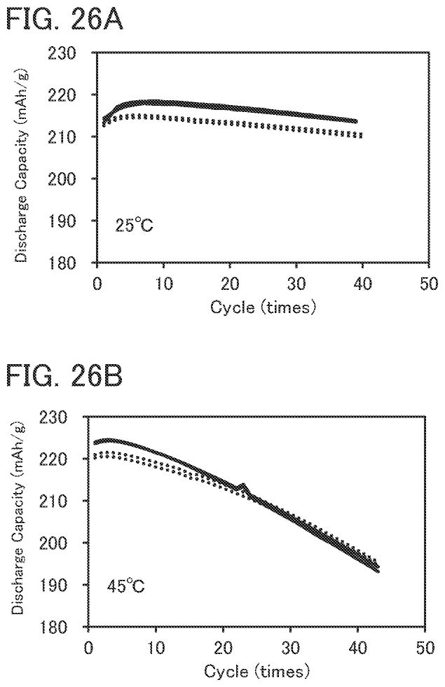

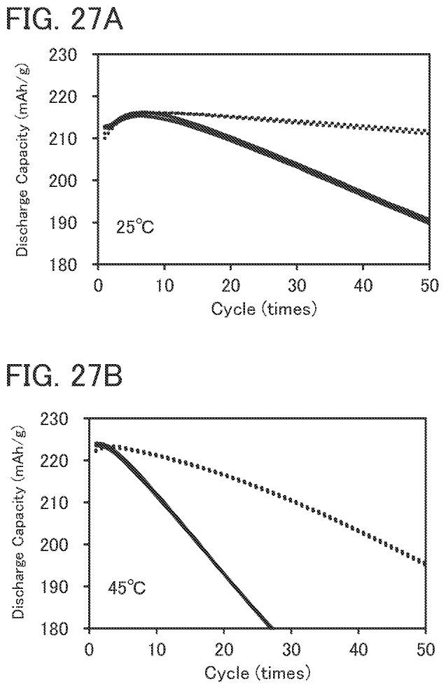

CCCV charge (0.5 C, 4.6 V, termination current: 0.05 C) and CC discharge (0.5 C, 2.5 V) were repeatedly performed on the fabricated secondary batteries at 25° C. or 45° C., and the cycle performance was evaluated. FIG. 26A, FIG. 26B, FIG. 27A, and FIG. 27B show the results. In FIG. 26A, FIG. 26B, FIG. 27A, and FIG. 27B, the horizontal axis represents cycles and the vertical axis represents discharge capacity.

FIG. 26A and FIG. 26B show cycle performance of the secondary batteries using Sample 1 and Sample 2 as the positive electrode active material. The solid line denotes Sample 1, and the dashed line denotes Sample 2. FIG. 26A shows the results of cycle performance at 25° C., and FIG. 26B shows the results of cycle performance at 45° C.

FIG. 27A and FIG. 27B show cycle performance of the secondary batteries using Sample 3 and Sample 4 as the positive electrode active material. The solid line denotes Sample 3, and the dashed line denotes Sample 4. FIG. 27A shows the results of cycle performance at 25° C., and FIG. 27B shows the results of cycle performance at 45° C.

In the case where the amount of the mixture 903 in the annealing was 2.4 g, excellent cycle performance was obtained for both cases of using aluminum fluoride and aluminum hydroxide as an aluminum source.

On the other hand, when comparing the cycle performances in the case where the amount of the mixture 903 in the annealing was 30 g, a more significant effect was obtained in the case of using aluminum fluoride than in the case of using aluminum hydroxide. As described above, the DSC results indicate that aluminum fluoride is less likely to inhibit a eutectic reaction between aluminum fluoride and magnesium fluoride. By using aluminum fluoride in manufacturing the positive electrode active material of one embodiment of the present invention, the reaction was able to be favorably controlled in the fabrication of the positive electrode active material, and the secondary battery having excellent performance was obtained.

### REFERENCE NUMERALS

SW1: switch, SW2: switch, SW3: switch, 78i: current, 91: substance, 92: substance, 93: substance, 94: substance, 95: metal oxide, 100: positive electrode active material, 210: electrode stack, 211a: positive electrode, 211b: negative electrode, 212a: lead, 212b: lead, 214: separator, 215a: bonding portion, 215b: bonding portion, 217: fixing member, 250: secondary battery, 251: exterior body, 261: bent portion, 262: seal portion, 263: seal portion, 271: crest line, 272: trough line, 273: space, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: glasses-type device, 400a: frame, 400b: display portion, 401: headset-type device, 401a: microphone portion, 401b: flexible pipe, 401c: earphone portion, 402: device, 402a: housing, 402b: secondary battery, 403: device, 403a: housing, 403b: secondary battery, 405: watch-type device, 405a: display portion, 405b: belt portion, 406: belt-type device, 406a: belt portion, 406b: wireless power feeding and receiving portion, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 610: gasket, 611: PTC element, 612: safety valve mechanism, 613: conductive plate, 614: conductive plate, 615: module, 616: wiring, 617: temperature control device, 900: circuit board, 902: mixture, 903: mixture, 904: mixture, 910: label, 911: terminal, 912: circuit, 913: secondary battery, 914: antenna, 915: sealant, 916: layer, 917: layer, 918: antenna, 920: display device, 921: sensor, 922: terminal, 930: housing, 930a: housing, 930b: housing, 931: negative electrode, 932: positive electrode, 933: separator, 950: wound body, 951: terminal, 952: terminal, 980: secondary battery, 981: film, 982: film, 993: wound body, 994: negative electrode, 995: positive electrode, 996: separator, 997: lead electrode, 998: lead electrode, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8000: display device, 8001: housing, 8002: display portion, 8003: speaker portion, 8004: secondary battery, 8021: charging device, 8022: cable, 8024: secondary battery, 8025: secondary battery, 8100: lighting device, 8101: housing, 8102: light source, 8103: secondary battery, 8104: ceiling, 8105: sidewall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 8400: automobile, 8401: headlight, 8406: electric motor, 8500: automobile, 8600: motor scooter, 8601: side mirror, 8602: secondary battery, 8603: direction indicator, 8604: under-seat storage, 9600: tablet terminal, 9625: switch, 9626: switch, 9627: switch, 9628: operation switch, 9629: faster, 9630: housing, 9630a: housing, 9630b: housing, 9631: display portion, 9631a: display portion, 9631b: display portion, 9633: solar cell, 9634: charge and discharge control circuit, 9635: power storage unit, 9636: DCDC converter, 9637: converter, 9640: movable portion

1. A method for manufacturing a positive electrode active material, the method comprising the steps of:
pulverizing a compound comprising an element X, a compound comprising halogen and an alkali metal, and a metal fluoride respectively;
forming a first mixture by mixing the pulverized compound comprising an element X, the pulverized compound comprising halogen and an alkali metal, and the pulverized metal fluoride with powder of a metal oxide; and
heating the first mixture at a temperature higher than or equal to 700° C. and lower than or equal to 950° C.,
wherein the element X is one or more selected from magnesium, calcium, zirconium, lanthanum, and barium,
wherein the metal fluoride comprises one or more selected from nickel, aluminum, manganese, titanium, vanadium, iron, and chromium, and
wherein the metal oxide comprises one or more selected from cobalt, manganese, nickel, and iron.

2. The method for manufacturing a positive electrode active material, according to claim 1,
wherein an average particle diameter of the positive electrode active material is greater than or equal to 1 μm and less than or equal to 100 μm.

3. The method for manufacturing a positive electrode active material, according to claim 1,
wherein the metal oxide has a structure represented by a space group R-3m.

4. The method for manufacturing a positive electrode active material, according to claim 3,
wherein the metal oxide is lithium cobalt oxide.

5. A method for manufacturing a positive electrode active material, the method comprising the steps of:
pulverizing magnesium fluoride, lithium fluoride, and aluminum fluoride respectively;
forming a first mixture by mixing the pulverized magnesium fluoride, the pulverized lithium fluoride, and the pulverized aluminum fluoride with powder of a metal oxide; and
heating the first mixture at a temperature higher than or equal to 700° C. and lower than or equal to 950° C.,
wherein the metal oxide comprises a metal M, and
wherein the metal M is one or more selected from cobalt, manganese, nickel, and iron.

6. The method for manufacturing a positive electrode active material, according to claim 5,
wherein in the first mixture, a number of atoms of magnesium contained in the magnesium fluoride is greater than or equal to 0.005 times and less than or equal to 0.05 times a number of atoms of the metal M contained in the metal oxide.

7. The method for manufacturing a positive electrode active material, according to claim 5,
wherein in the first mixture, a number of atoms of aluminum contained in the aluminum fluoride is greater than or equal to 0.0005 times and less than or equal to 0.02 times a sum of a number of atoms of the metal M contained in the metal oxide and a number of atoms of the aluminum contained in the aluminum fluoride.

8. The method for manufacturing a positive electrode active material, according to claim 5,
wherein an average particle diameter of the positive electrode active material is greater than or equal to 1 μm and less than or equal to 100 μm.

9. The method for manufacturing a positive electrode active material, according to claim 5,
wherein the metal oxide has a structure represented by a space group R-3m.

10. The method for manufacturing a positive electrode active material, according to claim 9,
wherein the metal oxide is lithium cobalt oxide.

11. A method for manufacturing a positive electrode active material, the method comprising the steps of:
pulverizing magnesium fluoride, lithium fluoride, a nickel compound, and aluminum fluoride respectively;
forming a first mixture by mixing the pulverized magnesium fluoride, the pulverized lithium fluoride, the pulverized nickel compound, and the pulverized aluminum fluoride with powder of a metal oxide; and
heating the first mixture at a temperature higher than or equal to 700° C. and lower than or equal to 950° C.,
wherein the metal oxide comprises a metal M, and
wherein the metal M is one or more selected from cobalt, manganese, nickel, and iron.

12. The method for manufacturing a positive electrode active material, according to claim 11,
wherein the nickel compound is nickel hydroxide.

13. The method for manufacturing a positive electrode active material, according to claim 11,
wherein in the first mixture, a number of atoms of magnesium contained in the magnesium fluoride is greater than or equal to 0.005 times and less than or equal to 0.05 times a number of atoms of the metal M contained in the metal oxide.

14. The method for manufacturing a positive electrode active material, according to claim 11,
wherein in the first mixture, a number of atoms of aluminum contained in the aluminum fluoride is greater than or equal to 0.0005 times and less than or equal to 0.02 times a sum of a number of atoms of the metal M contained in the metal oxide and a number of atoms of the aluminum contained in the aluminum fluoride.

15. The method for manufacturing a positive electrode active material, according to claim 11,
wherein an average particle diameter of the positive electrode active material is greater than or equal to 1 μm and less than or equal to 100 μm.

16. The method for manufacturing a positive electrode active material, according to claim 11,
wherein the metal oxide has a structure represented by a space group R-3m.

17. The method for manufacturing a positive electrode active material, according to claim 16,
wherein the metal oxide is lithium cobalt oxide.
